(19) United States
(12) Patent Application Publication
(10) Pub. No.: US 2005/0136245 A1
(43) Pub. Date: Jun. 23, 2005

(54) Intermediate transfer medium, film forming liquid for the intermediate transfer medium and image forming apparatus using intermediate transfer medium

(76) Inventors: Hitoshi Arita, Yokohama-shi (JP); Yasuo Hirano, Yokohama-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/010,328

(22) Filed: Dec. 14, 2004

(30) Foreign Application Priority Data
Dec. 19, 2003 (JP) 2003-422391
Dec. 19, 2003 (JP) 2003-423870
Nov. 11, 2004 (JP) 2004-327755

(51) Int. Cl. B32B 5/16; B32B 27/06

(52) U.S. Cl. 428/323; 428/473.5

(57) ABSTRACT

An intermediate transfer medium including a layer which includes an acidic carbon black including volatile components of from 3.5 to 8.0% by weight; at least one of a water soluble resin having a weight average molecular weight of from 3,000 to 30,000, and a resin dispersant having a weight average molecular weight of from 3,000 to 300,000 which is selected from the group consisting of polyamide acids, polyimides, and block copolymer including a unit containing at least one of a polyamide acid and a polyimide; and a binder resin, wherein a weight ratio (CB/R) of the carbon black (CB) to the at least one (R) of the water soluble resin and the resin dispersant is from 3/1 to 10/1. A film forming liquid for use in preparing the layer, and an image forming apparatus using the intermediate transfer medium are also provided.

### BACKGROUND OF THE INVENTION

1. Field of the Invention

The present invention relates to an intermediate transfer medium such as intermediate transfer drums and belts for use in electrophotographic image forming apparatus which form images using primary and secondary image transfer processes. In addition, the present invention also relates to a film forming liquid for forming a layer or the entire of the intermediate transfer medium and an electrophotographic image forming apparatus which forms a toner image using the intermediate transfer medium.

2. Discussion of the Background

Recently, electrophotographic image forming apparatus which can produce full color images have been commercialized. Among these color image forming apparatus, image forming apparatus using a double transfer method (hereinafter referred to as an intermediate transfer method) in which yellow (Y), magenta (M), cyan (C) and black (Bk) color images formed on one image bearing members (such as photoreceptors) or respective image bearing member are transferred on an intermediate transfer medium one by one and the multi-color image is then transferred on a receiving material at the same time to produce a full color image are widely used because of having advantages in that images can be produced on various receiving materials (i.e., paper free image formation) and images can be formed on both sides of receiving materials.

The intermediate transfer media are broadly classified into the following two types:
(1) intermediate transfer media, the entire of which is made of a dielectric material or whose uppermost layer, on which a toner image is to be transferred, is made of a dielectric material; and
(2) intermediate transfer media made of a material having a medium electric resistance.

The first type intermediate transfer media have a drawback in that charges formed thereon due to application of a transfer bias thereto or friction between the intermediate transfer media and other members affect the secondary transfer process, and thereby a discharge device has to be provided therefor, resulting in increase in manufacturing costs of the image forming apparatus. Therefore, the second type intermediate transfer media have been typically used.

With respect to the second type intermediate transfer media, published unexamined Japanese Patent Applications Nos. (hereinafter referred to as JP-As) 63-311263, 56-164368 and 64-74571 have proposed an intermediate transfer medium having a specific surface resistivity; an intermediate transfer medium made of a specific material; and an intermediate transfer medium including a specific resistance controlling agent.

In general, materials such as polycarbonate resins, polyvinylidene fluoride, ethylene-tetrafluoroethylene copolymers (ETFE), and polyimides are used as a binder resin for intermediate transfer media. Since these materials are insulative, resistance controlling agents (hereinafter sometimes referred to as fillers) such as carbon blacks and metal oxides are included in the binder resin to control the resistance of the intermediate transfer medium.

However, when a large amount of filler is included in an intermediate transfer medium, the smoothness of the resultant intermediate transfer medium deteriorates, thereby causing problems such as formation of a toner film thereon, change of the toner charge, and deterioration of image qualities. In attempting to avoid occurrence of such problems, carbon blacks have been typically used as a filler.

Because of being excellent in heat resistance, mechanical properties, and resistance to chemicals and various rays, polyimide resins are used for various applications such as various film and sheet materials, enamel coating materials for electric wires, electronic parts, flexible print circuit boards, heat resistant substrates, semiconductor sealing materials, adhesives, and organic material-inorganic material complex materials.

It has been attempted to improve the physical properties of a polyimide resin by adding a particulate insulative material therein. For example, JP-A 63-172741 proposes a technique for improving heat resistance and decreasing heat expansion coefficient. JP-As 03-170548 and 06-145378 have disclosed a technique for improving slipping property and running durability. In addition, JP-A 01-121364 proposes a technique for improving printability, heat resistance and moisture-resistant adhesiveness.

Since compositions in which a carbon black is dispersed in a polyimide resin have good light blocking property and electroconductivity, the compositions are used for not only black matrixes used for color filers of liquid crystal display devices utilizing their good light blocking property, but also electroconductive paints, sheet heating elements, and electromagnetic waves absorbing sheets utilizing their good electroconductivity.

Polyimide resins are typically prepared by synthesizing a solvent-soluble polyamide acid and then heating the polyamide acid to a temperature not lower than 300° C. Therefore, in order to disperse a particulate insulative material in a polyimide resin, it is necessary to disperse the particulate insulative material in a polyamide acid solution. In this case, a dispersing method in which a mixture including a particulate insulative material and a polyamide acid solution is subjected to a dispersing treatment using a dispersing machine such as sand mills and ball mills, or a method in which a particulate insulative material is mixed with a polyamide acid varnish in a semi-liquid state and the mixture is kneaded by a dispersing machine such as three-roll mills is typically used.

However, since affinity of particulate insulative materials for polyamide acids is very bad, the particulate insulative materials agglomerate in the polyamide acid. In addition, polyamide acid solutions typically have a very high viscosity. Therefore, it is very hard to uniformly disperse a particulate insulative material in a polyamide acid. In attempting to avoid such a dispersion problem, a method in which a diamine compound and an acid anhydride are reacted in a dispersion including a particulate insulative material dispersed in an organic polar solvent to prepare a polyamide acid dispersion including the particulate insulative material is proposed in, for example, JP-A 06-145378. However, even though this dispersion method is used, the particulate insulative material tends to agglomerate because the particles thereof have high cohesive force with each other.

The thus agglomerated particles in such a dispersion typically have a particle diameter not less than 10 μm, and serve as a foreign material (i.e., an undesired particle) in the resultant film. Specifically, when the dispersion is coated to form a film, the resultant film has a rough surface, i.e., the surface has a low glossiness and poor appearance. In addition, such agglomerated particles inversely affect mechanical properties of the resultant film such as tensile strength and electric properties such as electric insulating property.

In attempting to uniformly disperse an electroconductive material such as carbon blacks in a polyamide acid solution, the following methods have been disclosed:
(1) a method in which a carbon black is mixed with a polyamide acid solution and the mixture is subjected to a dispersion treatment using a dispersing machine such as sand mills and ball mills;
(2) a method in which a carbon black is mixed with a polyamide varnish in a semi-liquid state and the mixture is kneaded by a dispersing machine such as three-roll mills; and
(3) a method in which a polyamide acid is synthesized in a carbon black dispersion.

However, even when these dispersion methods are used, a problem in that the carbon black agglomerates because the affinity of carbon black for polyamide acids is very poor. Therefore, it is very difficult to uniformly disperse a carbon black in a polyamide acid. As a result, the resultant polyimide film includes carbon black aggregates, and thereby the film has a rough surface and low glossiness. In addition, a problem in that the desired electric resistance cannot be imparted to the resultant film occurs.

Further, when a carbon black is included in an insulative resin to prepare a composition having a medium electric resistance for use in preparing an intermediate transfer medium by a molding method, the volume resistivity and surface resistivity of the resultant intermediate transfer medium vary. When such an intermediate transfer medium is used for an image forming method, a problem in that the toner transferring operation varies, resulting in variation of image qualities occurs.

Because of these reasons, a need exists for an intermediate transfer medium in which a particulate insulative or electroconductive material is uniformly dispersed and which has a good resistivity uniformity.

### SUMMARY OF THE INVENTION

Accordingly, an object of the present invention is to provide an intermediate transfer medium having good resistivity uniformity.

Another object of the present invention is to provide an image forming apparatus which can stably produce high quality images using an intermediate transfer medium.

Yet another object of the present invention is to provide a film forming liquid in which a particulate material is uniformly dispersed in a polyimide resin and by which a layer having a good resistivity uniformity can be formed.

Briefly these objects and other objects of the present invention as hereinafter will become more readily apparent can be attained by an intermediate transfer medium including:
a layer including:
   an acidic carbon black including volatile components of from 3.5 to 8.0% by weight;
   at least one of a water soluble resin having a weight average molecular weight of from 3,000 to 30,000, and a resin dispersant having a weight average molecular weight of from 3,000 to 300,000 which is used for dispersing the acidic carbon black in a water soluble organic solvent and which is selected from the group consisting of polyamide acids, polyimides, and block copolymers including a unit containing at least one of a polyamide acid and a polyimide; and
   a binder resin,
wherein the weight ratio (C/R) of the carbon black (C) to the at least one (R) of the water soluble resin and the resin dispersant is from 3/1 to 10/1 and preferably 10/3 to 10/1.

The weight average molecular weight of the water soluble resin is preferably from 5,000 to 15,000. When a water-soluble resin is used as the resin, the water-soluble resin is preferably selected from the group consisting of acrylic acid-butyl acrylate-methyl methacrylate copolymers, styrene-maleic acid ester-maleic anhydride copolymers, and polyvinyl pyrrolidone copolymers.

The weight average molecular weight of the resin dispersant is preferably from 5,000 to 150,000. The resin dispersant preferably includes a second unit having a biphenyl skeleton in an amount not less than 40% by mole.

The carbon black preferably includes volatile components in an amount of from 4.5 to 6.0% by weight. The carbon black preferably has an average particle diameter of from 10 nm to 300 nm.

The acidic carbon black is preferably a self-dispersible carbon black including a resin grafted on a surface of the carbon black by graft polymerization, or a self dispersible capsuled carbon black in which a carbon black is capsuled with a resin. The resin is preferably selected from the group consisting of acrylic acid-butyl acrylate-methyl methacrylate copolymers, styrene-maleic acid ester-maleic anhydride copolymers, and polyvinyl pyrrolidone copolymers. In this regard, “self-dispersible carbon black” means carbon blacks which can be dispersed in a solution or the like without a dispersant.

The binder resin preferably includes a resin selected from the group consisting of polyimides, modified polyimides and polyamideimides.

The intermediate transfer medium preferably has a surface resistivity of from 10⁸ to 10¹² Ω/□.

The intermediate transfer medium may consist of the layer or may include the layer and another layer. The intermediate transfer medium is preferably an endless belt.

As another aspect of the present invention, a film forming liquid is provided which includes:
an acidic carbon black including volatile components of from 3.5 to 8.0% by weight;
at least one of a water soluble resin having a weight average molecular weight of from 3,000 to 30,000, and a resin dispersant selected from the group consisting of polyamide acids, polyimides, and block copolymer including a unit containing at least one of a polyamide acid and a polyimide, which has a weight average molecular weight of from 3,000 to 300,000; and
a binder resin,
wherein the weight ratio (C/R) of the carbon black (C) to the at least one (R) of the water soluble resin and the resin dispersant is from 3/1 to 10/1 and preferably 10/3 to 10/1.

As yet another aspect of the present invention, an image forming apparatus is provided which includes:
at least one image bearing member;
at least one charger configured to charge the at least one image forming apparatus to form an electrostatic latent image on the image bearing member;
at least one developing device configured to develop the electrostatic latent image to form a toner image;
a transfer device configured to transfer the toner image onto a receiving material via an intermediate transfer medium; and
a fixing device configured to fix the toner image on the receiving material,
wherein the intermediate transfer medium is the above-mentioned intermediate transfer medium.

These and other objects, features and advantages of the present invention will become apparent upon consideration of the following description of the preferred embodiments of the present invention taken in conjunction with the accompanying drawings.

### BRIEF DESCRIPTION OF THE DRAWINGS

Various other objects, features and attendant advantages of the present invention will be more fully appreciated as the same becomes better understood from the detailed description when considered in connection with the accompanying drawings in which like reference characters designate like corresponding parts throughout and wherein:

FIG. 1 is a schematic view illustrating an embodiment of the image forming apparatus of the present invention, which is a revolver type color image forming apparatus having only one photoreceptor drum; and

FIG. 2 is a schematic view illustrating an embodiment of the image forming apparatus of the present invention, which is a tandem type color image forming apparatus having four photoreceptor drums.

### DETAILED DESCRIPTION OF THE INVENTION

At first, the image forming apparatus of the present invention will be explained.

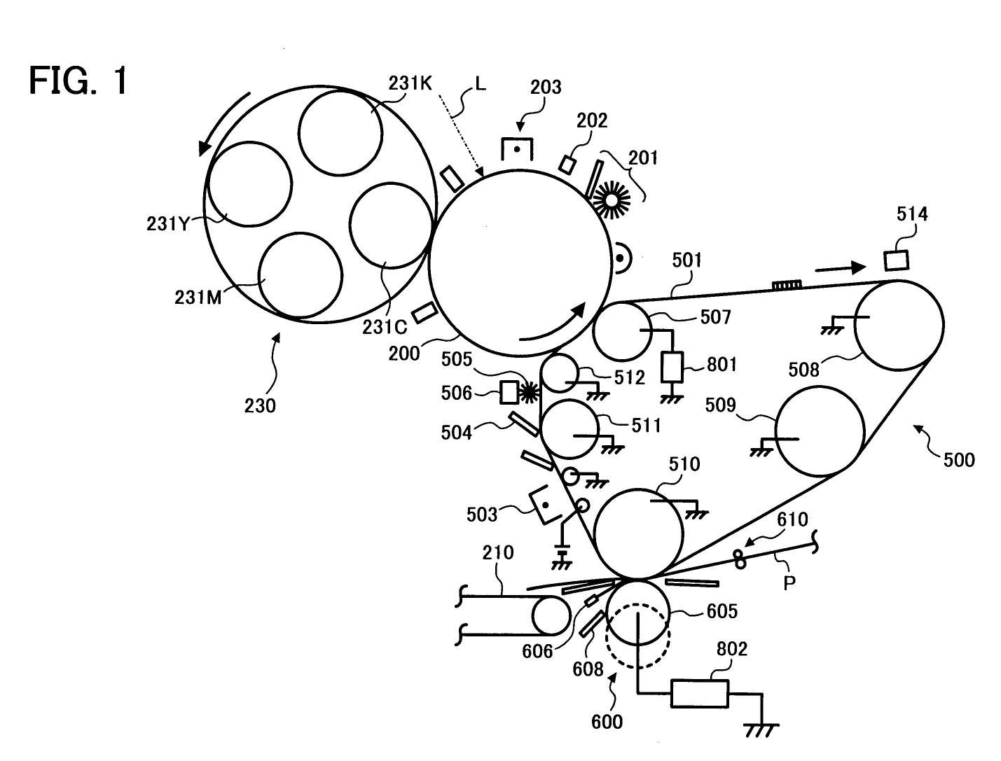

FIG. 1 is a schematic view illustrating a revolver type color image forming apparatus which uses only one photoreceptor and which is an embodiment of the image forming apparatus of the present invention. As illustrated in FIG. 1, the image forming apparatus includes an intermediate transfer belt as the intermediate transfer medium.

In FIG. 1, an intermediate transfer unit 500 includes an intermediate transfer belt 501 which is tightly stretched by a plurality of rollers. Around the intermediate transfer belt 501, a secondary transfer bias roller 605 of a secondary transfer unit 600, which is configured to apply a secondary bias to the intermediate transfer belt 501, a belt cleaning blade 504 configured to clean the surface of the intermediate transfer belt 501, a lubricant applying brush 505 configured to apply a lubricant to the surface of the intermediate transfer belt 501, etc. are arranged so as to face the intermediate transfer belt 501.

In addition, a position detecting mark is formed on an outer or inner surface of the intermediate transfer belt 501. When the position detecting mark is formed on the outer surface of the intermediate transfer belt 501, it is preferable that the mark is located at a position so as not to contact the cleaning blade 504. If it is impossible, the mark is formed on an inner surface thereof. In FIG. 1, an optical sensor 514 which serves as a sensor for detecting the position detecting mark is arranged at a location between a primary bias roller 507 and a driving roller 508, which rollers support the intermediate transfer belt 501.

The intermediate transfer belt 501 is tightly stretched by the primary transfer bias roller 507, the driving roller 508, a tension roller 509, a secondary transfer counter roller 510, a cleaner counter roller 511 and a feedback current detecting roller 512. These rollers are formed of electroconductive materials, and all rollers except for the primary bias roller 507 are grounded. A transfer bias, the current or voltage of which is adjusted on the basis of the number of the toner images overlaid on the intermediate transfer belt 501, is applied to the primary transfer bias roller 507 by a primary transfer power source 801 which is controlled so as to supply an electric power having a constant current or a constant voltage.

The intermediate transfer belt 501 is rotated by the driving roller 508 in a direction indicated by an arrow, wherein the driving roller 508 is driven by a driving motor (not shown) The intermediate transfer belt is semiconductive or insulative and has a single-layer structure or a multi-layer structure. Since the toner images formed on a photoreceptor 200 are transferred onto the intermediate transfer belt while overlaid, the intermediate transfer belt 501 has a width larger than that of largest sheets of the receiving material.

The secondary transfer bias roller 605 serving as secondary transferring means is attached to or detached from the outer surface of the intermediate transfer belt 501 by an attaching and detaching mechanism which will be explained later. The secondary transfer bias roller 605 is arranged such that a receiving material P is sandwiched by the secondary transfer bias roller 605 and a portion of the intermediate transfer belt 501 supported by the secondary transfer counter roller 510. A transfer bias with a predetermined current is applied to the secondary transfer bias roller 605 by a secondary transfer power source 802 which is controlled so as to supply an electric power having a constant current.

At a predetermined time, the pair of registration rollers 610 timely feeds the receiving paper P serving as a receiving material to a nip between the secondary transfer bias roller 605 and a portion of the intermediate transfer medium 501 supported by the secondary transfer counter roller 510. A cleaning blade 608 is arranged so as to contact the secondary transfer bias roller 605, to remove materials adhered to the surface thereof.

Then the image forming operations of the image forming apparatus having such a construction will be explained. When an image forming operation is started, the photoreceptor drum 200 is rotated by a driving motor (not shown) in a direction indicated by an arrow, and a black (Bk) toner image, a cyan (C) toner image, a magenta (M) toner image and a yellow (Y) toner image are formed one by one on the photoreceptor drum 200. The intermediate transfer belt 501 is rotated by the driving roller 508 in the direction indicated by the arrow. The Bk, C, M and Y toner images are transferred to the intermediate transfer belt 501 (primary transfer) by the transfer bias applied to the primary transfer bias roller 507. Thus, the Bk, C, M and Y toner images are overlaid on the intermediate transfer belt 501 in this order.

Then, formation of the toner images will be explained. In FIG. 1, a charger 203 performs corona discharging so that the photoreceptor has a predetermined negative potential. On the basis of a signal which is produced when the optical sensor 514 detects the position mark of the belt, raster light irradiation is timely performed on the thus charged photoreceptor 200 using a laser light beam emitted by a light irradiator (not shown) and modulated according to the Bk image signal. Thereby the charge of portions of the photoreceptor exposed to the light beam is decayed so as to be proportional to the quantities of the light beam, resulting in formation of an electrostatic latent image corresponding to the Bk image on the photoreceptor drum 200. When the thus prepared Bk latent image is contacted with a Bk toner which is located on a developing roller of a Bk developing device 231K and which is negatively charged, the Bk toner is selectively adhered to the lighted portions because the toner is repulsed by the negatively charged portions (i.e., the non-lighted portions) of the photoreceptor drum 200. Thus, a Bk toner image which is the same as the Bk latent image is formed on the photoreceptor drum 200.

The Bk toner image on the photoreceptor drum 200 is then transferred (primary transfer) onto the outer surface of the intermediate transfer belt 501 which is rotated at the same speed as that of the photoreceptor drum 200 while contacted therewith. Toner particles remaining on the surface of the photoreceptor drum 200 even after the primary transfer process is removed by a photoreceptor cleaner 201. Thus, the photoreceptor drum 200 is ready for the next image formation.

On the other hand, similarly to the Bk toner image, a cyan latent image is formed on the photoreceptor drum 200 by irradiating the photoreceptor drum, which is previously charged, with a laser light beam L modulated by cyan image data.

At a time after the rear edge of the Bk latent image passes the developing unit 230 and before the front edge of the C latent image reaches the developing unit 230, the developing unit 230 is rotated so that a C developing device 231Y takes the developing position. Then the C latent image is developed with the y developing device 231Y using a C toner.

Similarly to the Bk and C toner image formation, a M toner image and a Y toner image are formed on the photoreceptor drum 200 using a M developing device 231M and a Y developing device 231Y while the developing unit 230 is rotated in a direction indicated by an arrow.

The Bk, C, M and Y toner images formed on the photoreceptor drum 200 are transferred one by one to proper positions of the intermediate transfer belt 501, resulting in formation of a toner image including four color toner images at the most.

On the other hand, the receiving paper P, which is fed from a paper cassette or a manual paper-feeding tray, is stopped by the pair of the registration rollers 610. Then the receiving paper P is timely fed along a guide plate by the pair of registration rollers 610 so that the toner image on the intermediate transfer belt 501 is transferred to the predetermined position of the receiving paper P at the nip between the intermediate transfer belt 501 and the secondary transfer bias roller 605.

Thus, the toner image on the intermediate transfer belt 501 is transferred (secondary transfer) at the same time onto the receiving paper P by the transfer bias applied to the secondary transfer bias roller 605 by the secondary transfer power source 802. The receiving paper P on which the toner image is transferred is then fed along the guide plate while discharged with a discharging device 606 having a discharging needle. Then the receiving paper P bearing the toner image is then fed toward a fixing device by a belt feeder 210. After the toner image is fixed on the receiving paper P by a fixing roller of the fixing device (not shown), the receiving paper P bearing a fixed toner image thereon is discharged from the main body of the image forming apparatus and stacked on a copy tray (not shown).

On the other hand, the surface of the photoreceptor drum 200 is cleaned with the photoreceptor cleaner 201 and then is subjected to a discharge treatment using a discharge lamp 202. In addition, toner particles remaining on the outer surface of the intermediate transfer belt 501 are removed with the belt cleaner 504. The belt cleaner 504 is attached to or detached from the outer surface of the intermediate transfer belt 501 by a cleaner attaching/detaching mechanism (not shown).

On an upstream side from the belt cleaner 504 relative to the rotating direction of the intermediate transfer belt 501, a toner sealing member 503 configured to receive the toner particles scraped off by the belt cleaner 504, resulting in prevention of the toner particles from being scattered on the receiving paper P. The toner sealing member 503 and the belt cleaner 504 are attached to or detached from the outer surface of the intermediate transfer belt 501 by the cleaner attaching/detaching mechanism.

The thus cleaned surface of the intermediate transfer belt 501 is supplied with a lubricant by the brush 505 which scrapes off the surface of a lubricant 506. Suitable materials for use as the lubricant 506 include solid lubricants such as zinc stearate. Charges remaining on the intermediate transfer belt 501 are removed by a discharge bias applied by a discharge brush. The brush 505 and the discharge brush are attached to or detached from the outer surface of the intermediate transfer belt 501 by a attaching/detaching mechanism (not shown).

When plural copies are produced, a first color (Bk) image forming operation for the second copy image is started at a predetermined time after the fourth color (Y) image forming operation for the first copy image is completed. On the other hand, the intermediate transfer belt 501 is cleaned with the belt cleaner 504 after the secondary transfer process of the first image. The Bk toner image of the second image is then transferred (primary transfer) to the predetermined position of the thus cleaned intermediate transfer belt 501. Then C, M and Y toner images for the second copy image are similarly formed and transferred on the predetermined position of the thus cleaned intermediate transfer belt 501.

Hereinbefore, formation of a full color image including four color toner images is described. However, a multi-color image including three color toner images or two color toner images can also be prepared by forming the predetermined color toner images using the image forming method mentioned above. When a mono-color image is prepared, the developing operation is performed while the predetermined developing device (231 Bk, Y, M or C) of the revolver developing unit 230 is staying at the developing position until the predetermined number of copies are produced and the belt cleaner is contacting the intermediate transfer belt 501.

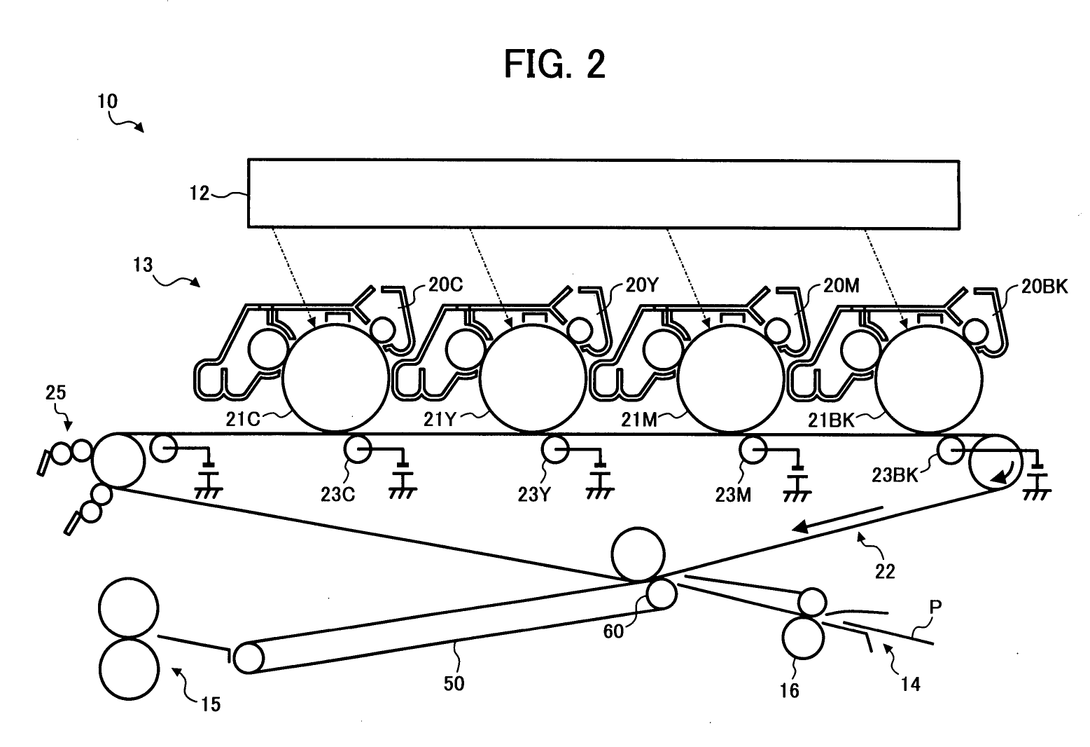

The above-mentioned embodiment of the image forming apparatus has only one photoreceptor drum. However, image forming apparatus of the present invention is not limited thereto. For example, a tandem type image forming apparatus in which a plurality of photoreceptor drums are serially arranged along an intermediate transfer medium as illustrated in FIG. 2 can also be used.

FIG. 2 is a schematic view illustrating a digital color printer having four photoreceptor drums 21Bk, 21M, 21Y and 21C configured to bear Bk, M, Y and C toner images, respectively.

The color printer includes a main body 10 of the printer illustrated in FIG. 2. The main body 10 includes an image writing device 12 which emits imagewise laser light, an image forming section 13 and a paper feeding section 14. Image signals for Bk, M, Y and C color images, which are produced by an image processor on the basis of the original color image signals, are sent to the image writing device 12. The image writing device 12 is a laser scanning optical device including, for example, a laser light source, a deflector such as polygon mirrors, a scanning focussing optical device, and a group of mirrors. The writing device 12 has four light passages through which light irradiation is performed on the respective photoreceptor drums 21Bk, 21M, 21Y and 21C to form Bk, M, Y and C latent images thereon.

The image forming section 13 includes four photoreceptor drums 21Bk, 21M, 21Y and 21C for Bk, M, Y and C color image formation, respectively. In this regard, organic photoconductors are typically used for the photoreceptor drums. Around each of the photoreceptor drums, a charger configured to charge the photoreceptor, a lighting portion from which laser light emitted by the image writing device 12 irradiates the photoreceptor, a developing device 20Bk, 20M, 20Y or 20C, a primary transfer bias roller 23Bk, 23M, 23Y or 23C, a cleaner and other devices such as a discharger are arranged. The developing device 20 uses a two component magnet brush developing method. An intermediate transfer belt 22 is located between the photoreceptor drum 21 and the primary bias roller 23. Color toner images formed on the photoreceptor drums 21 are transferred to the intermediate transfer belt 22.

The receiving paper P fed from the paper feeding section 14 is by a pair of registration roller 16 and then held by a feeding belt 50. The toner images formed on the intermediate transfer belt 22 are secondarily transferred to the receiving paper P by a secondary transfer bias roller 60 at a point in which the intermediate transfer belt 22 is contacted with the feeding belt 50. Thus color toner images are formed on the receiving paper P. The receiving paper P bearing the color toner images thereon is fed to a fixing device 15 by the feeding belt 50, and the color toner images are fixed on the receiving paper P, resulting in formation of a full color image. The receiving paper P bearing the full color image thereon is then discharged from the main body 10.

Toner particles remaining on the surface of the intermediate transfer belt 22 even after the secondary transfer process are removed by a belt cleaner 25. On a downstream side from the belt cleaner 25 relative to the rotation direction of the intermediate transfer belt 22, a lubricant applicator is provided. The lubricant applicator includes a solid lubricant and an electroconductive brush configured to apply the lubricant to the surface of the intermediate transfer belt 22 which rubbing the intermediate transfer belt 22. By applying a lubricant to the surface of the intermediate transfer belt 22, the cleanability of the belt 22 can be improved and thereby formation of a toner film on the belt 22 can be prevented.

The image forming apparatus of the present invention is not limited to the image forming apparatus using the intermediate transfer belt 501 or 22, and image forming apparatus using a feeding belt instead of the intermediate transfer belt can also be used. Such image forming apparatus may include only one photoreceptor or a plurality of photoreceptors.

Then the intermediate transfer medium of the present invention will be explained.

The intermediate transfer medium of the present invention includes at least a layer including an acidic carbon including volatile components in an amount of from 3.5 to 8% by weight, a water soluble resin having a weight average molecular weight of from 3000 to 30000 and a binder resin, wherein the weight ratio (C/R) of the carbon black (C) to the water soluble resin (R) is from 3/1 to 10/1.

Alternatively, the layer may include an acidic carbon including volatile components in an amount of from 3.5 to 8% by weight, a polymer such as polyamide acids, polyimides and block polymers including a polyamide acid unit or a polyimide unit, which polymer serves as a dispersant for use in dispersing the carbon black in a water soluble organic solvent and which has a weight average molecular weight of from 3,000 to 300,000, and a binder resin, wherein the weight ratio (C/D) of the carbon black (C) to the dispersant (D) is from 3/1 to 10/1.

At first, the carbon black included in the layer will be explained.

Carbon blacks are defined as aggregates of fine spherical particles of a carbon black prepared by subjecting a compound including carbon such as hydrocarbons to incomplete combustion and include carbon in an amount not less than 98% by weight.

In general, carbon blacks are classified as illustrated in Table 1 on the basis of the manufacturing methods thereof.

TABLE 1

| | | Main source |
|---|---|---|
| Manufacturing method | | materials |
| Thermal | Thermal method | natural gasses |
| decomposition | Acetylene decomposition | acetylene |
| method | method | |
| Incomplete | Contact method (channel | natural gasses, |
| combustion | method, gas black method | aromatic oils |
| method | and disc method) | |
| | Lamp and vegetable black | mineral oils, |
| | method | vegetable oils |
| | Gas furnace method | natural gasses, |
| | | aromatic |
| | | hydrocarbon oils |
| | Oil furnace method | |

The manufacturing methods are broadly classified into thermal decomposition methods in which hydrocarbons are thermally decomposed, and incomplete combustion methods in which hydrocarbons are subjected to incomplete combustion. In addition, the methods are further classified into several methods depending on the source materials. The contact method is such that flame is contacted with a material such as iron and stones to prepare a carbon black on the surface thereof. The channel method and gas black method (i.e., roller method) which is a modified method of the channel method are included in the contact method. Channel black is a typical product prepared by the channel method, and is prepared by contacting a flame, which is obtained by partially burning a fuel such as natural gas, town gas and hydrocarbons, with a bottom surface of a channel steel (i.e., a cold surface) to produce carbon black on the bottom surface.

The furnace method is such that source materials (such as natural gas and hydrocarbons) are continuously mixed with heated air to be partially burned or decomposed in a closed reaction furnace heated, resulting in formation of carbon black. The furnace methods are broadly classified into gas furnace methods and oil furnace methods.

The thermal method is such that source materials (i.e., natural gasses) are alternately subjected to combustion and heat decomposition, and is characterized by preparing carbon black with a large particle diameter.

The method for preparing acetylene black is a kind of thermal method. The heat decomposition of acetylene is an exothermic reaction whereas heat decomposition of other materials is an endothermic reaction. Therefore, it is not necessary to omit the combustion process, and thereby a continuous operation can be performed. The thus prepared acetylene black is characterized by having a relatively high crystallinity compared to other carbon blacks. In addition, because of having good electroconductivity, acetylene black is used for batteries, and is used as an electroconductivity imparting agent for rubbers and plastics.

When carbon black is used for rubbers, resins and paints to improve the strength, blackness and electroconductivity thereof, the important characteristics of the carbon black are particle diameter; structure; and physicochemical properties of the surface of particles.

These characteristics are referred to as three major characteristics of carbon black. By changing these characteristics, various carbon blacks are prepared.

Specifically, the three major characteristics are as follows:

(1) Particle diameter: particle diameter, and surface area of particles.

(2) Structure: DBP oil absorption (ml/100 g), and structure index.

(3) Physicochemical properties of surface: content of volatile components, and pH.

As a result of the present inventors' experiment in which carbon black is used as a resistance controlling agent for an intermediate transfer medium, it is found that the following is very important to prepare an intermediate transfer medium having good resistance uniformity.

(1) Carbon black including volatile components in an amount of from 3.5 to 8.0% by weight, and preferably from 4.5 to 6.0% by weight, is used.

(2) At least one of the following materials is used as a dispersant for carbon black.

2-1) Water soluble resins having a weight average molecular weight of from 3,000 to 30,000, and preferably from 5,000 to 15,000.

2-2) Polyamide acids, polyimides and block polymers including a repeat unit of polyamide acid or polyimide, which have a weight average molecular weight of from 3,000 to 300,000, and preferably from 5,000 to 150,000.

(3) The ratio of the carbon black to the water soluble resin (2-1)) or the resin (2-2)) is from 3/1 to 10/1, and preferably from 10/3 to 10/1.

It is found that using these techniques provides a film forming liquid in which carbon black is stably dispersed and by which a layer of the intermediate transfer medium, which has a uniform resistance, can be prepared. Thus, the present invention is made.

In the present application, the acidic carbon black means carbon blacks having an acidic group on the surface thereof. Among these acidic carbon blacks, carbon blacks having a pH not greater than 5 and including volatile components in an amount of from 3.5 to 8.0% by weight are preferably used for (the layer of) the intermediate transfer medium of the present invention.

The reason why use of a carbon black having a pH not greater than 5 imparts a good resistance uniformity to the resultant intermediate transfer medium or a layer thereof is not yet determined, but it is considered as follows. Since these carbon blacks have many acidic groups on the surface thereof, the carbon blacks have good affinity for the solvent used for preparing the film forming liquid therefor and thereby the carbon blacks can be finely dispersed in the film forming liquid, resulting in formation of an intermediate transfer medium (or a layer thereof) having a good resistance uniformity.

The reason why use of a carbon black including volatile components in an amount not less than 3.5% by weight imparts a good resistance uniformity to the resultant layer is not yet determined, but it is considered as follows. Since these carbon blacks have many acidic groups on the surface thereof, the carbon blacks have good affinity for the solvent used for preparing the film forming liquid and thereby the carbon blacks can be finely dispersed in the film forming liquid, resulting in formation of an intermediate transfer medium (or a layer thereof) having a good resistance uniformity.

When the intermediate transfer medium is prepared by centrifugal molding method using a liquid including a carbon black, the resistance uniformity is not further improved even when the volatile component content of the carbon black is greater than 8.0% by weight. In addition, carbon blacks having the volatile component content greater than 8.0% by weight tend to have poor dispersibility. Therefore, the volatile component content of the carbon black used for the film forming liquid is preferably from 3.5 to 8.0% by weight.

Acidic carbon blacks for use in the present invention can be produced by subjecting a carbon black to an oxidization treatment using nitric acid, or the like materials.

Suitable resins for use as the water soluble resin include any water soluble resins which can be dissolved in water including an amine and which have a weight average molecular weight of from 3,000 to 30,000. Specific examples thereof include styrene-acrylic acid copolymers, styrene-acrylic acid-acrylic alkyl ester copolymers, styrene-maleic acid copolymers, styrene-maleic acid-acrylic alkyl ester copolymers, styrene-methacrylic acid copolymers, styrene-methacrylic acid-acrylic alkyl ester copolymers, styrene-maleic half ester copolymers, vinyl naphthalene-acrylic acid copolymers, vinyl naphthalene-maleic acid copolymers, salts of these resins, etc.

Suitable materials for use as the resin dispersant (i.e., polyamide acid or polyimide) include any compounds which are prepared by reacting an aromatic carboxylic acid anhydride with an aromatic diamine compound and which can be dissolved in water including an amine while having a weight average molecular weight of from 3,000 to 30,000, and salts of the compounds.

The weight average molecular weight of the resins can be measured by various methods. In the present application, it is measured by gel permeation chromatography (GPC).

The content of the water soluble resin or the resin dispersant in the film forming liquid is preferably from 0.1 to 10% by weight.

The weight ratio of the carbon black to the water soluble resin or the resin dispersant is from 3/1 to 10/1, and preferably from 10/3 to 10/1, to stably produce an intermediate transfer medium having good resistance uniformity (i.e., good surface resistivity uniformity and volume resistivity uniformity). This is because the carbon black is stably dispersed in the film forming liquid even when environmental temperature changes.

By subjecting carbon blacks to a surface treatment, the characteristics of the carbon blacks such as dispersibility, wettability, rheology properties and electric properties can be improved. Suitable surface treatment methods include the following:

(1) Oxidization

By treating carbon blacks with an oxidizing agent, a group such as a carboxyl group and a phenolic hydroxyl group can be introduced in the condensed aromatic ring present on the surface of carbon black particles.

(2) Use of Surfactant

Carbon blacks can be well dispersed in a film forming liquid using a surfactant such as anionic surfactants, nonionic surfactants, cationic surfactants, ampholytic surfactants, etc.

(3) Use of Polymeric Dispersant (Resin Dispersant)

Carbon blacks can be well dispersed in a film forming liquid using a polymeric dispersant (dispersion stabilizer) due to steric hindrance effect of the chain portions of the polymeric dispersant.

(4) Encapsulation

Carbon blacks can be well dispersed in a film forming liquid when capsuled with a resin (i.e., carbon blacks are covered with a resin). Alternatively, resins including a carbon black on the surface thereof, inside the resins, or in entire the resins can also be used for a film forming liquid. By using this method, dispersibility, wettability, rheology properties and electric properties of the carbon blacks can be improved. In particular, the treated carbon blacks can be easily dispersed in a film forming liquid and in addition the dispersion stability can also be drastically improved due to the polymer chains grafted on the surface of the carbon blacks. In addition, the resultant carbon blacks can be easily and uniformly dispersed in a polymer matrix, and therefore the resultant film has good resistance uniformity.

(5) Grafting Treatment

Grafting treatments of carbon blacks are broadly classified into the following methods on the basis of grafting mechanism.

(a) Graft Polymerization in the Presence of Carbon Black

One or more vinyl monomers are polymerized in the presence of a carbon black using an initiator. In this case, polymer chains growing in the system is caught by surface of the carbon black.

(b) Graft Polymerization on the Surface of Carbon Black

Graft polymerization is started (i.e., polymer chains grow) from the polymerization starting groups formed on the surface of a carbon black.

(c) Reaction of Functional Group on the Surface of Carbon Black with Reactive Polymer

Functional groups on the surface of carbon black are reacted with a reactive polymer.

The method (a) can be easily performed, but has a drawback in that the grafting ratio is low because non-grafted polymer chains are dominantly formed. The method (b) has an advantage in that the grafting ratio is high because grafted polymer chains grow outward from the surface of the carbon black. The method (c) has an advantage in that the molecular weight and number of the grafted polymer chains can be controlled, and the grafting ratio is high.

(6) Vapor Phase Oxidization

Carbon blacks are subjected to an ozone treatment or a plasma treatment to oxidize the surface of the carbon blacks. By irradiating a carbon black with plasma, groups such as hydroxyl groups and carboxyl groups can be formed on the surface of the carbon black. This is because such groups can be adhered to the surface of the carbon black upon application of high energy of plasma thereto.

The above-mentioned methods are explained in detail.

(1) Oxidization

By treating a carbon black with an oxidizing agent, groups such as carboxyl groups and phenolic hydroxyl groups can be formed on the condensed aromatic rings present on the surface of the carbon black. In addition, since the condensed aromatic rings can be reacted with the following agents, various groups can be introduced on the surface of carbon blacks.
Φ-H+HNO₃→Φ-COOH and Φ-OH
Φ-H+H₂O₂→Φ-OH
Φ-H+HNO₃/H₃SO₄→Φ-NO₂ (reduction)→(Φ-NH₂
Φ-H+CH₂O/OH⁻→Φ-CH₂OH
Φ-H+R—Cl/AlCl₃→Φ-R
Φ-H+HOOC—R—N═N—R—COOH→Φ-R—COOH
Φ-H+X-Φ-COOCOO-Φ-X→Φ-OCO-Φ-X
Φ-H+BuLi/TMEDA→Φ-Li
Φ-H+NaNH₂→Φ-Na
   (2) Use of Surfactant

Among anionic surfactants, nonionic surfactants, cationic surfactants, and ampholytic surfactants, the following can be preferably used for treatment of carbon blacks.

Suitable surfactants include polyoxyethylenealkylether acetic acid salts, dialkylsulfosuccinate, polyoxyethylenealkylethers, polyoxyethylenealkylphenylethers, polyoxyethylene polyoxypropylene block copolymers, acetylene glycol based surfactants. Specific examples of the anionic surfactants include polyoxyethylenealkylether acetic acid salts having the below-mentioned formula (II) and dialkylsulfosuccinate having a branched hydrocarbon chain having from 5 to 7 carbon atoms and having the below-mentioned formula (III).
R—O—(CH₂CH₂O)ₘCH₂COOM (II)
wherein R represents an alkyl group having 6 to 14 carbon atoms, which may be branched; m is an integer of from 3 to 12; and M represents an alkali metal ion, a quaternary ammonium group, a quaternary phosphonium group, or an alkanolamine group. 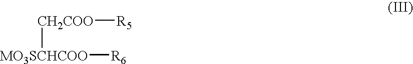
wherein R₅ and R₆ independently represent a branched alkyl group having 5 to 7 carbon atoms; and M represents an alkali metal ion, a quaternary ammonium group, a quaternary phosphonium group, or an alkanolamine group.

It is preferable that the surfactants include Li, a quaternary ammonium ion, or a quaternary phosphonium ion as a counter ion, because the resultant surfactants have good solubility.

Suitable nonionic surfactants include polyoxyethylenealkylphenylethers having the following formula (IV) and acetyleneglycol based surfactants. 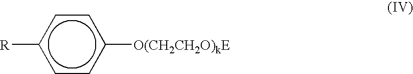
wherein R represents a carbon chain having from 6 to 14 carbon atoms; and k is an integer of from 5 to 12. 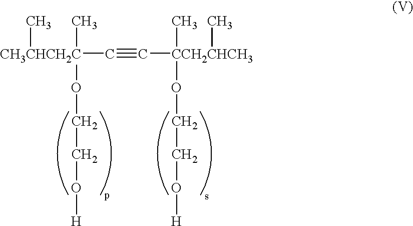
wherein p and s are independently 0 or an integer of from 1 to 40.
(3) Use of Polymeric Dispersant (Resin Dispersant)

In the present invention, a dispersion stabilizer can be added to the film forming liquid to improve the affinity of the carbon black for the dispersion medium of the film forming liquid. Suitable materials for use as the dispersion stabilizer include polymeric dispersion stabilizers but are not limited thereto. Specific examples of the polymeric dispersion stabilizers include poly(N-vinyl-2-pyrrolidone), poly(N,N′-diethyleacrylamide), poly(N-vinylformamide), poly(N-vinylacetamide), poly(N-vinylphthalamide), poly(N-vinylsuccinamide), poly(N-vinylurea), poly(N-vinylpiperidone), poly(N-vinylcaprolactam), poly(N-vinyloxazoline), etc. These polymers can be used alone or in combination. In addition, other dispersion stabilizers such as polymers, surfactants and inorganic salts can also be used.

(4) Grafting Treatment

At first, introduction of functional groups on the surface of carbon blacks will be explained. Carbon blacks have functional groups, such as phenolic hydroxyl groups and carboxyl groups, on the surface thereof. These functional groups can serve as a base of a graft reaction. By changing such functional groups into groups having higher reaction ability, various polymer graft reactions can be performed thereon.

(a) Graft Polymerization in the Presence of Carbon Black

When one or more vinyl monomers are subjected to radical polymerization in the presence of a carbon black, part of the resultant polymer is grafted on the surface of the carbon black.

(b) Graft Polymerization on the Surface of Carbon Black

The following polymerization can be performed.

1) radical polymerization
i) peroxide and peroxyester groups
ii) azo groups

2) cationic graft polymerization
i) acyliumperchlorate groups
ii) chloromethyl groups
iii) benzylium perchlorate groups

3) anionic graft polymerization
i) potassium carboxylate groups
ii) carbon black/BuLi complexes (OLi groups)
iii) amino groups

(c) Graft Polymerization of Carbon Black with Polymer

1) Reaction of reactive carbon black with polymer

2) Reaction of carbon black with reactive polymer
i) Reaction of carbon black with a living polymer
ii) Reaction of carbon black with a polymer having an isocyanate group at its end position

Among these surface treatment methods, the method using a polymeric dispersion stabilizer, the graft polymerization method, and the encapsulation method are preferably used.

Suitable materials for use as the binder resin in the intermediate transfer medium (or a layer thereof) of the present invention include thermoplastic resins and thermosetting resins such as polyimide resins, polyamide resins, polyamideimide resins and polyvinylidene fluoride resins, etc., which are insoluble in water. The binder resin in (the layer of) the intermediate transfer medium does not have an ability of dispersing carbon blacks because of not causing steric hindrance effect. Therefore the binder resin can be clearly distinguished from the water soluble resins mentioned above serving as a dispersant. Among the above-mentioned resins, polyimide resins, polyamideimide resins and polyvinylidene fluoride resins are preferably used, and particularly polyimide resins are more preferably used.

The binder resin is included in (the layer of) the intermediate transfer medium in an amount of 25 to 100 parts by weight, preferably from 29 to 66 parts by weight, and more preferably from 33 to 50 parts by weight, per 10 parts of the total of the acidic carbon black and the water soluble resin or resin dispersant. When the content of the binder resin is too high, a layer having a proper electric resistance cannot be formed. In contrast, when the content is too low, problems in that the electric resistance excessively decreases; the smoothness of the surface of the resultant intermediate transfer medium deteriorates; the rigidity of the surface of the intermediate transfer medium excessively increases, and thereby the toner receiving ability of the intermediate transfer medium is deteriorated tend to occur.

The layer of the intermediate transfer medium of the present invention can include other resins such as thermoplastic resins and thermosetting resins, e.g., epoxy resins, acrylic resins, urethane resins, and vinyl chloride resins in an amount such that the desired properties are not deteriorated. These resins are added to the film forming liquid or are kneaded with the constitutional materials of the layer of the intermediate transfer medium. The added amount of such resins is determined on the basis of the properties and added amount of the carbon black used, the properties and added amount of the binder resin and crosslinking agent used, and application of the intermediate transfer medium, but is generally not greater than 50% by weight.

Then polyimide resins for use in the layer of the intermediate transfer medium will be explained.

Polyimide resins are generally prepared by reacting an aromatic polycarboxylic acid anhydride or its derivative with an aromatic diamine (i.e., condensation reaction). Because the main chain thereof is rigid, polyimide resins are insoluble in solvents and are not melted by heat. Therefore, at first, an acid hydride and an aromatic diamine are reacted to synthesize a polyamic acid (or polyamide acid or a polyimide precursor) which can be dissolved in organic solvents. The thus prepared polyamic acid is subjected to molding, followed by dehydration/cyclization treatment (i.e., formation of a polyimide) upon application of heat or using a chemical method. The process is as follows. 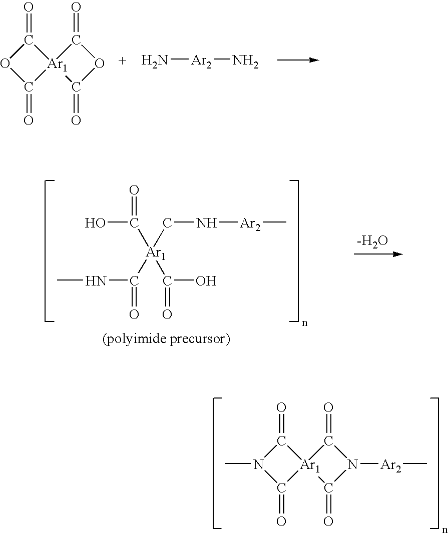
In the formula, Ar₁ represents a tetravalent aromatic group including at least one six-carbon ring; and Ar₂ represents a divalent aromatic group.

Specific examples of the aromatic polycarboxylic acid anhydrides include ethylenetetracarboxylic acid dihydride, cyclopentanetetracarboxylic acid dihydride, pyromellitic acid dihydride, 3,3′,4,4′-benzophenonetetracarboxylic acid dihydride, 2,2′,3,3′-benzophenonetetracarboxylic acid anydride, 3,3′,4,4′-biphenyltetracarboxylic acid dihydride, 2,2′,3,3′-biphenyltetracarboxylic acid dihydride, 2,2-bis(2,3-dicarboxyphenyl)propane dihydride, bis(3,4-dicarboxyphenyl)ether dihydride, bis(3,4-dicarboxyphenyl)sulfone dihydride, 1,1-bis(2,3-dicarboxyphenyl)ethane dihydride, bis(2,3-dicarboxyphenyl)methane dihydride, bis(3,4-dicarboxyphenyl)methane dihydride, 2,2-bis(3,4-dicarboxyphenyl)-1,1,1,3,3,3-hexafluoropropane dihydride, 2,3,6,7-naphthalenetetracarboxylic acid dihydride, 1,4,5,8-naphthalenetetracarboxylic acid dihydride, 1,2,5,6-naphthalenetetracarboxylic acid dihydride, 1,2,3,4-benzenetetracarboxylic acid dihydride, 3,4,9,10-perylenetetracarboxylic acid dianhydride, 2,3,6,7-anthracenetetracarboxylic acid dianhydride, 1,2,7,8-phenanthreneteracarboxylic acid dihydride, etc. These compounds can be used alone or in combination.

Specific examples of the aromatic diamine compounds include m-phenylenediamine, o-phenylenediamine, p-phenylenediamine, m-aminobenzylamine, p-aminobenzylamine, 4,4′-diaminodiphenyl ether, 3,3′-diaminodiphenyl ether, 3,4′-diaminodiphenyl ether, bis(3-aminophenyl)sulfide, (3-aminophenyl)(4-aminophenyl)sulfide, bis(4-aminophenyl)sulfide, bis(3-aminophenyl)sulfide, (3-aminophenyl)(4-aminophenyl)sulfoxide, bis(3-aminophenyl)sulfone, (3-aminophenyl)(4-aminophenyl)sulfone, bis(4-aminophenyl)sulfone, 3,3′-diaminobenzophenone, 3,4′-diaminobenzophenone, 4,4′-diaminobenzophenone, 3,3′-diaminodiphenylmethane, 3,4′-diaminodiphenylmethane, 4,4′-diaminodiphenylmethane, bis[4-(3-aminophenoxy)phenyl]methane, bis[4-(4-aminophenoxy)phenyl]methane, 1,1-bis[4-(3-aminophenoxy)phenyl]ethane, 1,1-bis[4-(4-aminophenoxy)phenyl]ethane, 1,2-bis[4-(3-aminophenoxy)phenyl]ethane, 1,1-bis[4-(4-aminophenoxy)phenyl]ethane, 2,2-bis[4-(3-aminophenoxy)phenyl]propane, 2,2-bis[4-(4-aminophenoxy)phenyl]propane, 2,2-bis[4-(3-aminophenoxy)phenyl]butane, 2,2-bis[3-(3-aminophenoxy)phenyl]-1,1,1-3,3,3-hexafluoropropane, 2,2-bis[4-(4-aminophenoxy)phenyl]-1,1,1-3,3,3-hexafluoropropane, 1,3-bis(3-aminophenoxy)benzene, 1,3-bis(4-aminophenoxy)benzene, 1,4-bis(3-aminophenoxy)benzene, 1,4-bis(4-aminophenoxy)benzene, 4,4′-bis(3-aminophenoxy)biphenyl, 4,4′-bis(4-aminophenoxy)biphenyl, bis[4-(3-aminophenoxy)phenyl]ketone, bis[4-(4-aminophenoxy)phenyl]ketone, bis[4-(3-aminophenoxy)phenyl]sulfide, bis[4-(4-aminophenoxy)phenyl]sulfide, bis[4-(3-aminophenoxy)phenyl]sulfoxide, bis[4-(4-aminophenoxy)phenyl]sulfoxide, bis[4-(3-aminophenoxy)phenyl]sulfone, bis[4-(4-aminophenoxy)phenyl]sulfone, bis[4-(3-aminophenoxy)phenyl]ether, bis[4-(4-aminophenoxy)phenyl]ether, 1,4-bis[4-(3-aminophenoxy)benzoyl]benzene, 1,3-bis[4-(3-aminophenoxy)benzoyl]benzene, 4,4′-bis[3-(4-aminophenoxy)benzoyl]diphenylether, 4,4′-bis[3-(3-aminophenoxy)benzoyl]diphenylether, 4,4′-bis[4-(4-amino-α, α-dimethylbenzyl)phenoxy]benzophenone, 4,4′-bis[4-(4-amino-α, α-dimethylbenzyl)phenoxy]diphenylsulfone, bis[4-{4-(4-aminophenoxy)phenoxy}phenyl]sulfone, 1,4-bis[4-{4-(4-aminophenoxy)phenoxy}-α, α-dimethylbenzyl]benzene, 1,3-bis[4-(4-aminophenoxy)-α, α-dimethylbenzyl]benzene, etc. These compounds are used alone or in combination.

By subjecting one or more of these aromatic polycarboxylic acid anhydride compounds and one or more diamine compounds, which are mixed in a molar ratio of about 1/1, to a polymerization reaction in an organic polar solvent, a polyimide precursor (i.e., polyamic acid) can be prepared.

Then the method for preparing polyamic acids will be explained.

Suitable organic polar solvents for use in the polymerization reaction include sulfoxides such as dimethylsulfoxide and diethylsulfoxide; formamides such as N,N-dimethylformamide and N,N-diethylformamide; acetamides such as N,N-dimethylacetamide and N,N-diethylacetamide; pyrrolidone based solvents such as N-methyl-2-pyrrolidone N-vinyl-2-pyrrolidone; phenolic solvents such as phenol, o-, m- or p-cresol, xylenol, halogenated phenol and catechol; ethers such as tetrahydrofuran, dioxane and dioxolan; alcohols such as methanol, ethanol and butanol; cellosolves such as butyl cellosolve; hexamethylphosphoramide, γ-butyrolactone, etc. These solvent are used alone or in combination. Among these solvents, N,N-dimethylacetamide and N-methyl-2-pyrrolidone are preferably used.

At first, in an inert gas (such as argon gas and nitrogen gas) environment, one or more diamines are dissolved in an organic solvent. Alternatively diamines are dispersed in an organic solvent to form a slurry. When one or more aromatic polycarboxylic acid anhydrides or their derivatives, which are in a solid state, or are dissolved or dispersed in an organic solvent, are added thereto, a ring opening reaction accompanied with generation of heat is induced. In this case, the viscosity of the mixture rapidly increases, and a polyamic acid with a high molecular weight is produced. In this case, the reaction temperature is preferably from −20° C. to 100° C., and more preferably not higher than 60° C. The reaction time is preferably form 30 minutes to 12 hours.

The addition order of diamines and polycarboxylic acid anhydrides is not limited thereto, and it is possible to add one or more diamines (in a form of solid, solution or dispersion) to polycarboxylic acid anhydrides (in a form of solution or dispersion) or to mix the compounds in a container at the same time.

The molar ratio of the one or more diamines to the one or more polycarboxylic acid anhydrides is preferably about 1/1.

By performing the above-mentioned reaction, a solution of a polyamic acid in which the polyamic acid is uniformly dissolved in the organic polar solvent can be prepared.

Thus, polyamic acids can be easily synthesized. However, polyamic acids can be commercially available as polyimide varnishes. Specific examples of the marketed polyamic acids include TORENEES (from Toray Ltd.), U-VARNISH (from Ube Industries Ltd.), RIKACOAT (from New Japan Chemical Co., Ltd.), OPTOMER (from Japan Synthetic Rubber Co., Ltd.), SE812 (from Nissan Chemical Industries, Ltd.), CRC8000 (from Sumitomo Bakelite Co., Ltd.), etc.

Various additives can be added to polyamic acids to improve various properties thereof. For example, surface tension controlling agents can be added thereto to improve the smoothness and the leveling property of the resultant layer. The surface tension controlling agents are referred to as leveling agents, antifoaming agents, or coating defect improving agents. Among these agents, silicone based additives are preferably used. In addition, non-silicone additives such as glycerin-higher fatty acid esters, higher alcohol-boric acid esters and fluorine-containing surfactants can also be preferably used. The added amount of these additives is preferably from 0.001 to 1% based on the total weight of the solids of the polyamic acid composition.

In addition, the polyamic acid composition can include a reinforcer. Specifci examples of the reinforcer include glass fibers, carbon fibers, aromatic polyamide fibers, silicon carbide fibers, potassium titanate fibers, glass beads, etc. These materials can be used alone or in combination.

Further, the polyamic acid composition can include a lubricant to improve the slipping property of the layer. Specific examples of the lubricant include molybdenum disulfide, graphite, boron nitride, lead monoxide, lead powders, etc. These materials can be used alone or in combination.

Furthermore, other additives such as antioxidants, heat stabilizers, ultraviolet absorbents, and colorants can also be added to the polyamic acid composition.

The electric resistance controlling agents for use in the polyimide resin are broadly classified into electronic conduction type resistance controlling agents and ionic conduction type resistance controlling agents.

Specific examples of the electronic conduction type resistance controlling agents include carbon blacks, graphite, metals such as copper, tin, aluminum and indium; powders of metal oxides such as tine oxides, zinc oxides, titanium oxides, indium oxides, antimony oxides, bismuth oxides, tin oxides which are subjected to antimony doping, and indium oxides which are subjected to tin doping.

Specific examples of the ionic conduction type resistance controlling agents include tetraalkylammonium salts, trialkylbenzylammonium salts, alkylsulfonic acid salts, alkylbenzenesulfonic acid salts, alkylsulfates, glycerin farry acid esters, sorbitane fatty acid esters, polyoxyethylenealkyl amines, polyoxyethylene-alphatic alcohol esters, alkylbetaine, lithium perchlorate, etc., but are not limited thereto.

Among these resistance controlling agents, carbon blacks are preferably used for polyimides. However, carbon blacks have high cohesive force, i.e., carbon black particles aggregate. Since the affinity of other resins or solvents for carbon black particles is smaller than the cohesive force of the carbon black particles, it is very difficult to uniformly disperse carbon black particles in a resin or a solvent. In order to solve this problem, various investigations such that carbon black particles are covered with a surfactant or a resin to improve the affinity of the carbon black particles therefor have been made.

In attempting to improve the dispersibility of carbon black, JP-As 63-175869 and63-158566, and UK patent Nos. 1583564 and 1583411 have disclosed methods in which carbon black is treated with a coupling agent. However, the method has drawbacks in that the treated carbon black is not satisfactorily dispersed in a polymerizable monomer, and manufacturing costs are high. In addition, JP-A 64-6965 and German patent No. 3102823 have disclosed methods in which monomers are polymerized in the presence of carbon black. However, these methods have a drawback in that the grafting efficiency is not high, and thereby the treated carbon black cannot be well dispersed in a polymerizable monomer. Further, JP-As 01-284564 and 05-241378 have disclosed the methods in which an organic compound is reacted with functional groups present on the surface of carbon black to graft a polymer on the surface.

Suitable organic compounds which is used for forming a graft polymer on the surface of carbon black include crosslinking monomers such as vinyl acetate, styrene compounds (e.g., styrene, o-methyl styrene, m-methyl styrene, p-ethyl styrene, p-methoxy styrene, p-bromostyrene, p-chlorostyrene and p-styrenesulfonic acid sodium salts); acrylates (e.g., methyl acrylate, ethyl acrylate, n-propyl acrylate, n-butyl acrylate, 2-ethylhexyl acrylate, and glycidyl acrylate); methacrylates (e.g., methyl methacrylate, ethyl methacrylate, n-propyl methacrylate, n-butyl methacrylate, and 2-ethylhexyl methacrylate); N-substituted acrylamide compounds (e.g., acrylonitrile, acrylamide, N-isopropylacrylamide, and N-piperylacrylamide); divinyl benzene, methylenebisacrylamide, 1,3-butanedioldimethacrylate, etc., but are not limited thereto.

The thus prepared polyamic acid can be changed to a polyamide by (1) a heating method or (2) a chemical method. In the heating method, the polyamic acid is heated at a temperature of from 200 to 350° C. The heating method has an advantage in that a polyamide resin can be easily prepared. In the chemical method, the polyamic acid is reacted with a dehydration ring forming agent such as mixtures of a carboxylic acid anhydride and a tertiary amine, and then the reaction product is heated. Thus, the chemical method is relatively complex compared to the heating method and therefore the manufacturing costs are relatively high. Accordingly, the heating method is popularly used.

When the polyamic acid is heated to be changed to a polyimide, the resultant polyimide does not have desired properties if the polyamic acid is heated to a temperature not lower than the glass transition temperature of the polyimide resin.

The imide changing rate (i.e., the degree of a polyamic acid changed to a polyimide) can be determined by any known methods which are used for measuring the imide changing rate. Specific examples thereof are as follows.
(1) a nuclear magnetic resonance (NMR) method in which the imide changing rate is determined on the basis of an integral ratio of 1H of the amide, group observed at 9 to 11 ppm to 1H of the aromatic group observed at 6-9 ppm;
(2) a Fourier transfer infrared spectrophotometric method (i.e., FT-IR method);
(3) a method in which water generated by forming an imide ring is determined; and
(4) a method in which residual carboxylic acid is determined by a neutralization titration method.

Among these methods, the FT-IR method is typically used. When the FT-IR method is used, the imide changing rate is determined as follows.
Imide changing rate=(Mia/Mii)×100
wherein Mia represents the number of moles of the imide group determined in the heating step; and Mii represents the number of moles of the imide group which is calculated while assuming that the polyamic acid is perfectly changed to the polyimide.

The imide changing rate can be determined by the absorbance ratio of the imide group to other groups. Specific examples of the absorbance ratio are as follows.
(1) a ratio of the absorbance of a peak at 725 cm⁻¹, which is caused by the bending vibration of the C═O group of the imide ring, to the absorbance of a peak at 1,015 cm⁻¹ which is specific to the benzene ring;
(2) a ratio of the absorbance of a peak at 1,380 cm⁻¹, which is caused by the bending vibration of the C—N group of the imide ring, to the absorbance of a peak at 1,500 cm⁻¹ which is specific to the benzene ring;
(3) a ratio of the absorbance of a peak at 1,720 cm⁻¹, which is caused by the bending vibration of the C═O group of the imide ring, to the absorbance of a peak at 1,500 cm⁻¹ which is specifice to the benzene ring; and
(4) a ratio of the absorbance of a peak at 1,720 cm⁻¹, which is specific to the C═O group of the imide ring, to the absorbance of a peak at 1,670 cm⁻¹ which is caused by the interaction of the bending vibration of the N—H group and the stretching vibration of the C—N group of the amide group.

In addition, if it is confirmed that the multiple absorption bands at 3000 to 3300 cm⁻¹ which are specific to the amide group disappear, the reliability of completion of the imide forming reaction is further enhanced.

Not only polyimide resins but also fluorine containing polyimide resins, silicone-modified polyimide resins and polyamideimide resins can also be used for the layer of the intermediate transfer medium.

Then the fluorine-containing polyimide resins are explained.

Polyimide resins are typically prepared by subjecting an aromatic polycarboxylic acid anhydride (or a derivative thereof) and an aromatic diamine to a condensation reaction. The process is as follows.

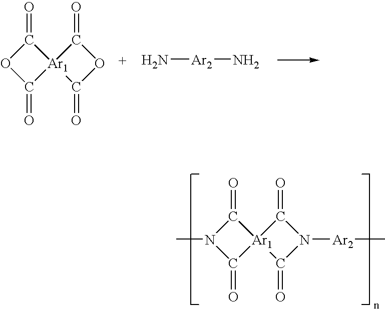

The fluorine containing polyimide resins for use in the present invention include at least one —CF₃ group in the group Ar₁ and/or the group Ar₂. By including the —CF₃ group in the polyimide resins, a releasability as good as that of fluorine-containing resins can be imparted to the polyimide resins while the good mechanical properties of the polyimide resins are maintained. The —CF₃ group can be incorporated in the group Ar₁ or the group Ar₂ by using an aromatic polycarboxylic acid anhydride including a —CF₃ group in the group Ar₁ and/or an aromatic diamine including a —CF₃ group in the group Ar₂.

Specific examples of the group Ar₁ in the aromatic polycarboxylic acid anhydrides which includes at least one —CF₃ group include (trifluoromethyl)pyromellitic acid, bis(trifluoromethyl)pyromellitic acid, 5,5′-bis(trifluoromethyl)-3,3′,4,4′-tetracarboxybiphenyl, 2,2′,5,5′-tetrakis(trifluoromethyl)-3,3′,4,4′-tetracarboxybiphenyl, 5,5′-bis(trifluoromethyl)-3,3′,4,4′-tetracarboxydiphenyl ether, 5,5′-bis(trifluoromethyl)-3,3′,4,4′-tetracarboxybenzophenone, bis[(trifluoromethyl)dicarboxyphenoxy]benzene, bis[(trifluoromethyl)dicarboxyphenoxy]biphenyl, bis[(trifluoromethyl)dicarboxyphenoxy](trifluoromethyl)-benzene, bis[(trifluoromethyl)dicarboxyphenoxy]bis(trifluoromethyl)-biphenyl, bis[(trifluoromethyl)dicarboxyphenoxy]diphenyl ether, bis(dicarboxyphenoxy)(trifluoromethyl)benzene, bis(dicarboxyphenoxy)bis(trifluoromethyl)benzene, bis(dicarboxyphenoxy)tetrakis(trifluoromethyl)benzene, bis(dicarboxyphenoxy)bis(trifluoromethyl)biphenyl, bis(dicarboxyphenoxy)tetrakis(trifluoromethyl)biphenyl, 2,2-bis(3,4-dicarboxyphenyl)hexafluoropropane, 2,2-bis[4-(3,4-dicarboxyphenoxy)phenyl]hexafluoropropane, etc.

Specific examples of the group Ar₂ in the aromatic diamines which includes at least one —CF₃ group include diaminobenzotrifluoride, bis(trifluoromethyl)phenylenediamine, diaminotetra(trifluoromethyl)benzene, diamino(pentafluoroethyl)benzene, 2,2′-bis(trifluoromethyl)benzidine, 3,3′-bis(trifluoromethyl)benzidine, 2,2′-bis(trifluoromethyl)-4,4′-diaminodiphenyl ether, 3,3′,5,5′-tetrakis(trifluoromethyl)-4,4′-diaminodiphenyl ether, 3,3′-bis(trifluoromethyl)-4,4′-diaminobenzophenone, bis(aminophenoxy)di(trifluoromethyl)benzene, bis(aminophenoxy)tetrakis(trifluoromethyl)benzene, bis[(trifluoromethyl)aminophenoxy]benzene, bis[(trifluoromethyl)aminophenoxy]biphenyl, bis[{(trifluoromethyl)aminophenoxy}phenyl]-hexafluoropropane, 2,2′-bistrifluoromethyl-4,4′-diaminobiphenyl, 2,2′-bis[4-(p-aminophenoxy)phenyl]hexafluoropropane, 2,2′-bis[4-(m-aminophenoxy)phenyl]hexafluoropropane, 2,2′-bis[4-(o-aminophenoxy)phenyl]hexafluoropropane, 2-[4-(p-aminophenoxy)phenyl]-2-[4-(m-aminophenoxy)phenyl]hexafluoropropane, 2-[4-(m-aminophenoxy)phenyl]-2-[4-(o-aminophenoxy)phenyl]hexafluoropropane, 2-[4-(o-aminophenoxy)phenyl]-2-[4-(p-aminophenoxy)phenyl]hexafluoropropane, etc.

When the fluorine-containing polyimde resins are prepared, at least one of the fluorine-containing aromatic polycarboxylic acid anhydrides and the fluorine-containing aromatic diamines is used. In this case, aromatic polycarboxylic acid anhydrides and aromatic diamines, which do not include a fluorine atom, can also be used in combination with the fluorine-containing aromatic polycarboxylic acid anhydrides and the fluorine-containing aromatic diamines.

Specific examples of the aromatic polycarboxylic acid anhydrides and aromatic diamines, which do not include a fluorine atom, are mentioned above.

The fluorine-containing polyimides for use in the layer of the intermediate transfer medium of the present invention can be prepared by any known methods. For example, one or more aromatic polycarboxylic acid anhydrides and one or more aromatic diamines, at least one of which includes a fluorine atom, are dissolved in a non-protonic polar solvent such as N-methyl-2-pyrrolidone, dimethylformamide, dimethylacetamide, dimethylsulfoxide, dimethylimidazoline, and hexamethylphosphoramide, and the mixture is agitated at room temperature or a temperature of from 40 to 80° C., resulting in formation of a polyamide acid which is a polyimide precursor and which includes a fluorine atom.

Polyamide acids are dissolved in a solvent such as amide solvents (e.g., N-methylpyrrolidone (NMP), N,N-dimethylformamide (DMF), and N,N-dimethylacetamide (DMAc)); polar solvents useful for polyamic acids and polyimides (e.g., y-butyrolactone); ethyl lactate, methoxymethyl propionate, propyleneglycol monomethyl ether acetate, etc., to prepare polyimide varnishes. The solid content and viscosity of polyimide varnishes are adjusted so that the polyimide varnished can be suitably used for the desired application. However, it is preferable that the added amount of the solvent is from 250 to 2,000 parts by weight per 100 parts by weight of the fluorine-containing polyimide (i.e., the solid content is adjusted so as to be from 5 to 30% by weight).

Then the thus prepared polyimide varnish is coated on a plate made of a material such as metals and glass using a proper coating means such as doctor blades and doctor knifes, followed by heating at a predetermined temperature. Thus a film of fluorine-containing polyimide can be prepared. In order to perfectly change the polyamide acid to the polyimide, the heating is preferably performed at a temperature of from 100 to 400° C. and more preferably from 200 to 350° C.

Silicone-modified polyimide resins can also be used for the layer of the intermediate transfer medium of the present invention. Silicone-modified polyimide resins typically have the following formula: 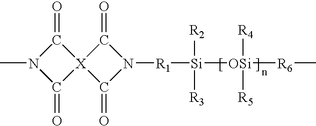
wherein X represents a tetravalent aromatic ring group or a tetravalent alicyclic group; R₁ and R₆ independently represent a divalent organic group; R₂ R₃, R₄ and R₅ independently represent an alkenyl group, an alkyl group, a phenyl group, or a substituted phenyl group; and n is an integer not less than 5.

In general, polyimide resins have high strength and high rigidity. However, when the main chain thereof has a siloxane structure, the resultant modified resins have good flexibility and releasability. Namely, the intermediate transfer medium including such a silicone-modified polyimide resin in at least the outermost layer has good abrasion resistance and toner releasability.

In the silicone-modified polyimide resins having the above-mentioned formula, the groups R₂ R₃, R₄ and R₅ are preferably a methyl group. It is possible to improve the properties (i.e., to reduce the friction coefficient) of surface of the intermediate transfer medium by incorporating a siloxane structure in the side chains of the polyimide resin included in the outermost layer thereof. As mentioned above, the intermediate transfer medium is contacted with various members in the image forming apparatus. Therefore, it is preferable to reduce the driving torque by controlling the friction coefficient of surface of the intermediate transfer medium so as to range from 0.2 to 0.4. By using a dimethyl siloxane-modified polyimide resin having the formula mentioned above in which the groups R₂ R₃, R₄ and R₅ are a methyl group, the desired friction coefficient can be imparted to the intermediate transfer medium.

Such silicone-modified polyimide resins can also be prepared by using a siloxane diamine, an aromatic diamine, and a tetracarboxylic acid anhydride as raw materials. Suitable materials for use as the siloxane diamine compounds include materials having the following formula:
H₂N—R₁SiR₂R₃—OₙSiR₄R₅—R₆—NH₂
wherein R₁ and R₆ independently represent a divalent organic group; R₂ R₃, R₄ and R₅ independently represent an alkyl group, a phenyl group or a substituted phenyl group; and n is an integer of from 5 to 50.

Specific examples of the siloxane diamine compounds include bis(3-aminopropyl)tetramethyldisiloxane, bis(10-aminodecamethylene)tetramethyldisiloxane, tetramers and octomers of dimethylsiloxane having an aminopropyl group at an end position thereof, bis(3-aminophenoxymethyl)tetramethyldisiloxane, etc.

Suitable materials for use as the aromatic diamine for use in preparing the silicone-modified polyimide resins include aromatic diamine compounds having two or more (preferably from 2 to 5) aromatic rings (such as benzene ring). Examples thereof are as follows:

(1) biphenyl type diamine compounds, diphenylether type diamine compounds, benzophenone type diamine compounds, diphenylsulfone type diamine compounds, diphenylmethane type diamine compounds, and diphenylalkane type diamine compounds (such as 2,2-bis(phenyl)propane).

(2) di(phenoxyphenyl)benzene type diamine compounds, and di(phenyl)benzene type diamine compounds.

(3) di(phenoxyphenyl)hexafluoropropane type diamine compounds, and bis(phenoxyphenyl)propane type diamine compounds.

Among these atomatic diamindes, diphenylether type diamine compounds such as 1,4-diaminodiphenyl ether and 1,3-diaminodiphenyl ether; di(phenoxy)benzene type diamine compounds such as 1,4-bis(4-aminophenoxy)benzene; and bis(phenoxyphenyl)propane type diamine compounds such as 2,2-bis[4-(4-aminophenoxy)phenyl]propane, and 2,2-bis[4-(3-aminophenoxy)phenyl]propane are preferably used.

Specific examples of the tetracarboxylic acid dianhydrides for use in preparing the polyimide resins include pyromellitic acid dianhydride, 3,3′,4,4′-diphenylsulfonetetracarboxylic acid dianhydride, 3,3′,4,4′-benzophenonetetracarboxylic acid dianhydride, 3,3′,4,4′-biphenyltetracarboxylic acid dianhydride, 2,3′,3,4′-biphenyltetracarboxylic acid dihydrate, bis(3,4-dicarboxyphenyl)ether dihydrate, 4,4′-bis(3,4-dicarboxyphenoxy)diphenylsulfone dihydrate, ethyleneglycol bistrimellitate dianhydride, 2,2-bis[4-(3,4-dicarboxyphenoxy)phenyl]propane dihydrate, 4,4′-diphenylsulfonetetracarboxylic acid dihydrate, 3,3′,4,4′-biphenyltetracarboxylic acid dihydrate, and 2,3′,3,4′-biphenyltetracarboxylic acid dihydrate.

The silicone-modified polyimide resins for use in the layer of the intermediate transfer medium of the present invention can be prepared using the above-mentioned compounds and a known production method. For example, the following methods can be used:

(1) a method in which the compounds are mixed and heated in an organic solvent optionally together with a catalyst such as tributyl amine, triethyl amine, and triphenyl phosphite, to directly prepare a polyimide.

(2) a method in which at first a tetracarboxylic acid dianhydride and a diamine are reacted in an organic solvent to prepare a polyamide acid (i.e., a polyimide precursor), and the polyamide acid is heated optionally together with a condensation catalyst such as p-toluenesulfonic acid to prepare a polyimide.

(3) a method in which the polyimide acid prepared above is subjected to a chemical ring forming reaction using a ring forming agent such as acid anhydride (e.g., acetic anhydride, propionic anhydride and benzoic anhydride), and carbodiimide compounds (e.g., dicyclohexylcarbodiimide) optionally together with a ring forming catalyst such as pyridine, isoquinoline, imidazole and triethylamine.

When the silicone-modified polyimide resins are prepared, a crosslinking agent which can crosslink the silicone unit in the silicone-modified polyimide can be used. Specific examples of the crosslinking agents include known peroxide type crosslinking agents such as benzoylperoxide, 2,4-dichlorobenzoylperoxide, dicumylperoxide, t-butylcumylperoxide, and 1,1-bis(t-butylperoxy)-3,3,5-trimethylcyclohexane. These crosslinking agents can be used alone or in combination. Among these crosslinking agents, benzoylperoxide is preferably used because of having good crosslinking ability.

The added amount of the crosslinking agent is preferably from 0.5 to 10 parts by weight per 100 parts by weight of the silicone-modified polyimide resin used. When the content of the crosslinking agent is too low, the crosslinking reaction is not satisfactorily performed. In contrast, when the content is too high, the releasability of the intermediate transfer medium deteriorates because residual crosslinking agent remains therein.

Polyamideimide resins can also be used for (a layer of) the intermediate transfer medium of the present invetion. Polyamideimide resins have both an imide group which is rigid and an amide group which can impart flexibility to the resins in the skeleton thereof. Known polyamideimide resins can be used for the intermediate transfer medium of the present invention.

Polyamideimide resins are typically prepared by the following methods:
(1) an isocyanate method in whcih a polyamideimide is prepared by reacting a tribasic carboxylic acid anhydride derivative with an aromatic isocyanate in a solvent (disclosed in, for example, published examined Japanese patent application No. 44-19274); and
(2) an acid chloride method in which a polyamideimide is prepared by reacting a halide (e.g., chloride) of a tribasic carboxylic acid anhydride derivative with a diamine in a solvent (disclosed in, for example, published examined Japanese patent application No. 42-15637).

Then the methods will be explained in detail.

(1) Isocyanate Method

Specific examples of the tribasic carboxylic acid anhydride derivatives include compounds having the following formula (I) and (II): 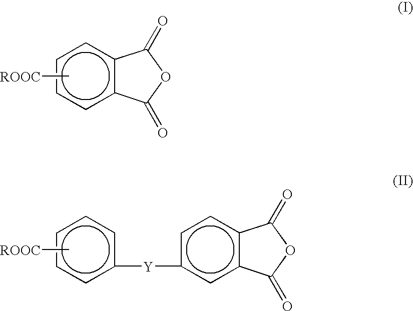
In formula (I) and (II), R represents a hydrogen atom, an alkyl group having from 1 to 10 carbon atoms, or a phenyl group; and Y represents —CH₂—, —CO—, —SO₂—, or —O—.

These tribasic carboxylic acid compounds can be used alone or in combination. Among these compounds, trimellitic acid anhydride is typically used.

Specific examples of the aromatic polyisocyanate compounds for use in preparing polyamideimide resins include 4,4-diphenylmethane diisocyanate, tolylene diisocyanate, xylene diisocyanate, 4,4′-diphenylether diisocyanate, 4,4′-[2,2-bis(4-phenoxyphenyl)propane]diisocyanate, biphenyl-4,4′-diisocyanate, biphenyl-3,3′-diisocyanate, biphenyl-3,4′-diisocyanate, 3,3′-dimethylbiphenyl-4,4′-diisocyanate, 2,2′-dimethylbiphenyl-4,4′-diisocyanate, 3,3′-diethylbiphenyl-4,4′-diisocyanate, 2,2′-diethylbiphenyl-4,4′-diisocyanate, 3,3′-dimethoxybiphenyl-4,4′-diisocyanate, 2,2′-dimethoxybiphenyl-4,4′-diisocyanate, naphthalene-1,5-diisocyanate, naphthalene-2,6-diisocyanate, etc. These compounds can be used alone or in combination.

If desired, other isocyanates having two or more isocyanate groups such as aliphatic isocyanates, and alicyclic isocyanates can also be used together with the above-mentioned isocyanate compounds. Specific examples thereof include hexamethylene diisocyanate, 2,2,4-trimethylhexamethylene diisocyanate, isophoronediisocyanate, 4,4′-dicyclohexylmethane diisocyanate, transcyclohexane-1,4-diisocyanate, hydrogenated m-xylylenediisocyanate, lysin diisocyanate, etc.

By using this isocyanate method, polyamideimide resins can be directly produced (i.e., without producing a polyamic acid) while generating a carbon dioxide gas. When a polyamideimide is prepared using trimellitic acid anhydride and an aromatic isocyanate, the reaction formula is as follows: 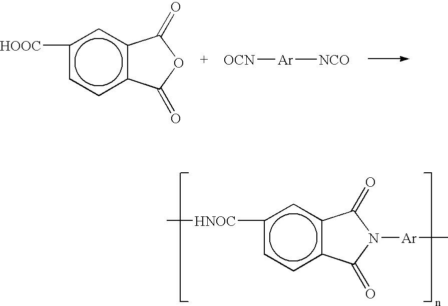
wherein Ar represents an aromatic group.
(2) Acid Chloride Method

Suitable compounds for use as the halide of tribasic carboxylic acid anhydride derivatives include compounds having the following formula (III) or (IV): 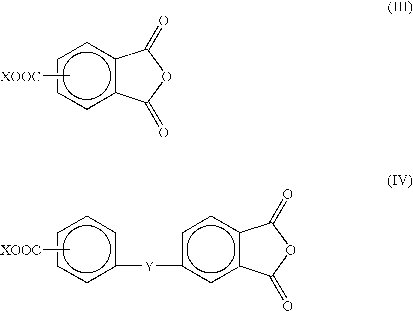
In formula (III) and (IV), X represents a halogen atom; and Y represents —CH₂—, —CO—, —SO₂—, or —O—.

Among the halogen atoms, the chlorine atom is preferably used.

Specific examples of the carboxylic acid derivatives of the halides of carboxylic acid derivatives include polycarboxylic acid derivatives such as terephthalic acid, isophthalic acid, 4,4′-biphenyldicarboxylic acid, 4,4′-biphenyletherdicarboxylic acid, 4,4′-biphenyletherdicarboxylic acid, 4,4′-biphenylsulfonedicarboxylic acid, 4,4′-benzophenonedicarboxylic acid, pyromellitic acid, trimellitic acid, 3,3′,4,4′-benzophenonetetracarboxylic acid, 3,3′,4,4′-biphenylsulfonetetracarboxylic acid, 3,3′,4,4′-biphenyltetracarboxylic acid, adipic acid, sebatic acid, maleic acid, fumaric acid, dimer acid, stilbenedicarboxylic acid, 1,4-cyclohexanedicarboxylic acid, 1,2-cyclohexanedicarboxylic acid, etc.

In this acid chloride method, any diamine compounds such as aromatic diamines, aliphatic diamines and alicyclic diamines can be used. Among these diamines, aromatic diamines are preferably used.

Specific examples of the aromatic diamines include m-phenylenediamine, p-phenylenediamine, oxydianiline, methylenediamine, hexafluoroisopropylidenediamine, diamino-m-xylylene, diamino-p-xylylene, 1,4-naphthalenediamine, 1,5-naphthalenediamine, 2,6-naphthalenediamine, 2,7-naphthalenediamine, 2,2′-bis-(4-aminophenyl)propane, 2,2′-bis-(4-aminophenyl)hexafluoropropane, 4,4′-diaminodiphenylsulfone, 4,4′-diaminodiphenyl ether, 3,3′-diaminodiphenyl sulfone, 3,3′-diaminodiphenyl ether, 3,4-diaminobiphenyl, 4,4′-diaminobenzophenone, 3,4-diaminodiphenyl ether, isopropylidenedianiline, 3,3′-diaminobenzophenone, o-tolidine, 2,4-tolylenediamine, 1,3-bis-(3-aminophenoxy)benzene, 1,4-bis(4-aminophenoxy)benzene, 1,3-bis(4-aminophenoxy)benzene, 2,2-bis-[4-(4-aminophenoxy)phenyl]propane, bis-[4-(4-aminophenoxy)phenyl]sulfone, bis-[4-(3-aminophenoxy)phenyl]sulfone, 4,4′-bis-[4-(4-aminophenoxy)phenyl]biphenyl, 2,2′-bis-[4-(4-aminophenoxy)phenyl]hexafluoropropane, 4,4′-diaminodiphenylsulfide, 3,3′-diaminodiphenylsulfide, etc.

By using a siloxane compound, which has an amino group at both end positions thereof, as a diamine, silicone-modified polyamideimide resins can be prepared. Specific examples of such silicone compounds include 1,3-bis(3-aminopropyl)-1,1,3,3-tetramethyldisiloxane, α,ω-bis(3-aminopropyl)polydimethylsiloxane, 1,3-bis(3-aminophenoxymethyl)-1,1,3,3-tetramethyldisiloxane, α,ω-bis(3-aminophenoxymethyl)polydimethylsiloxane, 1,3-bis[2-(3-aminophenoxy)ethyl]-1,1,3,3-tetramethyldisiloxane, α,ω-bis[2-(3-aminophenoxy)ethyl]polydimethylsiloxane, 1,3-bis[3-(3-aminophenoxy)propyl]-1,1,3,3-tetramethyldisiloxane, α,ω-bis[3-(3-aminophenoxy)propyl]polydimethylsiloxane, etc.

In the acid chloride method, polyamideimide resins can be prepared by a method similar to the method mentioned above for use in preparing polyimide resins. Specifically, one or more of the above-mentioned halides of tribasic carboxylic acid anhydride derivatives and one or more of the above-mentioned diamines are dissolved in an organic polar solvent and the mixture is reacted at a relatively low temperature of from 0 to 30° C. Thus, a polyamide acid (i.e., polyamic acid) is prepared.

Specific examples of the organic polar solvent for use in this reaction include sulfoxide type solvents such as dimethylsulfoxide and diethylsulfoxide; formamide type solvents such as N,N-dimethylformamide and N,N-diethylformamide; acetamide type solvents such as N,N-dimethylacetamide and N,N-diethylacetamide; pyrrolidone type solvents such as N-methyl-2-pyrrolidone, N-vinyl-2-pyrrolidone; phenolic solvents such as phenol, o-, m- and p-cresol, xylenol, halogenated phenol and catechol; ether solvents such as tetrahydrofuran, dioxane and dioxolan; alcoholic solvents such as methanol, ethanol and butanol; cellosolve solvents such as butylcellosolve; hexamethylphosphramide, γ-butyrolactone, etc. These solvents are used alone or in combination. The solvent is not particularly limited, and any solvents capable of dissolving the resultant polyamic acid can be used. Among the solvents, N,N-dimethylacetamide and N-methyl-2-pyrrolidone are preferably used.

Then the polyamic acid prepared above is changed to a polyamideimide by a condensation ring forming method or a chemical ring forming method. In the condensation ring forming method, the polyamic acid is heated to form a ring while dehydrating. In this case, the reaction temperature is preferably from 150 to 400° C., and more preferably from 180 to 350° C. In addition, the reaction time is preferably from 30 seconds to 10 hours, and more preferably from. 5 minutes to 5 hours. In the chemical ring forming method, the polyamic acid is subjected to a ring forming reaction using a catalyst. In this case, the reaction temperature is preferably from 0 to 180° C., and more preferably from 10 to 80° C. In addition, the reaction time is preferably from tens minutes to few days, and more preferably from 2 hours to 12 hours.

Then the film forming liquid for forming (a layer of) the intermediate transfer medium of the present invention will be explained.

The film forming liquid includes at least an acidic carbon black including volatile components in an amount of from 3.5 to 8.0% by weight, a water soluble resin having a weight average molecular weight of from 3000 to 30000, and a binder resin, wherein the weight ratio of the carbon black to the water soluble resin is from 3/1 to 10/1.

Alternatively, the film forming liquid may include at least an acidic carbon black including volatile components in an amount of from 3.5 to 8.0% by weight, a resin dispersant which has a weight average molecular weight of from 3,000 to 300,000 and which is selected from the group consisting of polyamide acids, polyimides and block polymers including at least one of a polyamide acid unit and a polyimide unit, and a binder resin, wherein the weight ratio of the carbon black to the resin is from 3/1 to 10/1.

As a result of the present inventors' investigation, it is found that when a carbon black having the following properties is used for the film forming liquid, the carbon black is stably dispersed in the resultant film forming liquid and the resultant film formed by the film forming liquid has good resistance uniformity.

(1) Carbon black including volatile components in an amount of from 3.5 to 8.0% by weight, and preferably from 4.5 to 6.0% by weight, is used.

(2) One of the following materials is used as a dispersant for carbon black.

2-1) Water soluble resins having a weight average molecular weight of from 3,000 to 30,000, and preferably from 5000 to 15000.

2-2) Polyamide acids, polyimides and block polymers including a repeat unit of polyamide acid or polyimide, which have a weight average molecular weight of from 3,000 to 300,000, and preferably from 5,000 to 150,000.

(3) The ratio of the carbon black used to the water soluble resin or the dispersant is from 3/1 to 10/1, and preferably from 10/3 to 10/1.

The acidic carbon black for use in the film forming liquid of the present invention means carbon blacks having an acidic group on the surface thereof. In the present invention, it is preferable to use carbon blacks having a pH not greater than 5 and including volatile component in an amount of from 3.5 to 8.0% by weight.

When an intermediate transfer medium is prepared using a film forming liquid including a carbon black having a pH not greater than 5, the resultant intermediate transfer medium has good resistance uniformity.

As mentioned above, the reason why a carbon black having a pH not greater than 5 imparts a good resistance uniformity to the resultant layer is not yet determined, but it is considered as follows. Since these carbon blacks have many acidic groups on the surface thereof, the carbon blacks have good affinity for the solvent used for preparing the film forming liquid and thereby the carbon blacks can be finely dispersed in the film forming liquid, resulting in formation of a layer having a good resistance uniformity.

In the present application, the pH of a carbon black is measured by the following method:
(1) one to 10 g of a sample of a carbon black is precisely weighed;
(2) the sample is placed in a beaker and water is added thereto in an amount of 10 ml per 1 g of the sample (a few drops of ethanol can be added so that the sample is wet with water);
(3) the mixture is heat for 15 minutes so that water boils while the beaker is covered with a watch glass;
(4) the boiled mixture is cooled to room temperature;
(5) the supernatant liquid of the cooled mixture is removed to obtain the sludge; and
(6) the pH of the sludge is measured by a method based on JIS Z8802 using a pH meter having a glass electrode while the glass electrode is inserted to the sludge.

When the glass electrode is inserted to the sludge, the measured pH value varies depending on the measurement positions (i.e., depending on how deeply the glass electrode is inserted) Therefore, it is important to change the measuring points by moving the beaker so that the glass electrode is fully contacted with the sludge. The pH of the sample is determined as the pH at which the measurement value stabilizes.

When a layer of an intermediate transfer medium is prepared using a film forming liquid including a carbon black including volatile components in an amount of from 3.5 to 8.0% by weight, the resultant layer has good resistance uniformity.

The reason why a carbon black including volatile components in an amount not less than 3.5% by weight imparts a good resistance uniformity to the resultant layer is not yet determined, but it is considered as follows. Since these carbon blacks have many acidic groups on the surface thereof, the carbon blacks have good affinity for the solvent used for preparing the film forming liquid and thereby the carbon blacks can be finely dispersed in the film forming liquid, resulting in formation of a layer having a good resistance uniformity.

When the intermediate transfer medium is prepared by centrifugal molding method using a film forming liquid including a carbon black, the resistance uniformity is not further improved even when the volatile component content of the carbon black is greater than 8.0% by weight. In addition, carbon blacks having the volatile component content greater than 8.0% by weight tend to have poor dispersibility. Therefore, the volatile component content of the carbon black used for the film forming liquid is preferably from 3.5 to 8.0% by weight.

In the present application, the volatile component content of a carbon black is measured by the following method:
(1) the weight of a platinum crucible (or a porcelain china) is measured;
(2) a sample of a carbon black, which has been previously dried, is contained in the platinum crucible (or the porcelain china) while tapped such that the gap between the upper surface of the sample and the cap of the crucible is not greater than 2 mm;
(3) the weight of the crucible including the sample therein is measured to determine the weight (WD) of the sample;
(4) after being capped, the crucible is set in an electric furnace to be heated for just 7 minutes at a temperature in the range of 950±25° C.;
(5) after the crucible is cooled to room temperature in a desiccator, the weight of the crucible without cap which includes the sample is measured to determine the weight (WR) of the heated sample; and
(6) the volatile component content (V) of the sample is determined by the following equation:
   V={(WD−WR)/WD}×100 (%)
   wherein V represents the content of volatile components in the sample, WD represents the weight of the dried sample of the toner, and WR represents the weight of the sample heated at a temperature in the range of 950±25° C.

Such acidic carbon blacks are commercially available. Specific examples of such acidic carbon blacks include MA7, MA8 and #2200B manufactured by Mitsubishi Kasei Corporation; RAVEN1255 manufactured by Columbian Carbon Co.; REGAL 400R and MOGUL L manufactured by Cabot Corp.; and COLOR BLACK FW1, COLOR BLACK FW18, COLOR BLACK S170, COLOR BLACK S150, and PRINTEX U, which are manufactured by Degussa A.G., but are not limited thereto. Namely, any carbon blacks satisfying the above-mentioned conditions can be used for the present invention.

The content of a carbon black in the film forming liquid of the present invention is preferably from 3 to 20% by weight based on the total weight of the film forming liquid.

The water soluble resin and the resin dispersant (such as polyamide acids, polyimides and polymers including a unit of polyamide acid and/or a polyimide), at least one of which is included in the film forming liquid, have a weight average molecular weight of from 3,000 to 30,000 and from 3,000 to 300,000, and preferably from 5,000 to 15,000, and from 5,000 to 150,000, respectively. Hereinafter, the water soluble resins and the resin dispersants are sometimes referred to as dispersion resins.

The reason why the dispersion resins having an average molecular weight in the ranges mentioned above produces good effects is considered as follows.

In general, polymers having a high average molecular weight tend to have a high viscosity when dissolved in an organic solvent if the solid content of the solution is constant. On the other hand, when a dispersion resin solution is mixed with a carbon black, the dispersion resin is adsorbed by the carbon black, resulting in formation of steric hindrance, thereby stably dispersing the carbon black in the resin solution. Therefore, when the average molecular weight of the dispersion resin increases, the thickness of the adsorption layer increases, resulting in increase of the particle diameter of the particles in the carbon black dispersion.

In particular, acidic carbon blacks have many acidic groups on the surface thereof, and the acidic groups repulse the carboxyl groups of the dispersion resins. Therefore, the particle diameter of the particles in the carbon black dispersion further increases. Therefore, in order to stably disperse an acidic carbon black in the film forming liquid, a dispersion resin having a relatively low weight average molecular weight is preferably used to decrease the particle diameter of the dispersed particles and to decrease the viscosity of the film forming liquid. However, when the average molecular weight of the dispersion resin is too low, the steric hindrance effect cannot be produced, resulting in deterioration of long term preservation of the film forming liquid. Therefore, the weight average molecular-weight is preferably from 3,000 to 30,000 (or 300,000).

Suitable resins for use as the water soluble resin for use in the film forming liquid include any known resins which has a weight average molecular weight of from 3,000 to 30,000 and which can be dissolved in water including an amine. Specific examples thereof include styrene-acrylic acid copolymers, styrene-acrylic acid-acrylic alkyl ester copolymers, styrene-maleic acid copolymers, styrene-maleic acid-acrylic alkyl ester copolymers, styrene-methacrylic acid copolymers, styrene-methacrylic acid-acrylic alkyl ester copolymers, styrene-maleic half ester copolymers, vinyl naphthalene-acrylic acid copolymers, vinyl naphthalene maleic acid copolymers, salts of these resins, etc.

Suitable resins for use as the resin dispersant include polyamide acids, polyimides, polymers including a unit of polyamide acid and/or polyimide, and salts thereof, which have a weight average molecular weight of from 3,000 to 300,000 and which can be dissolved in water including an amine.

The resin dispersant is prepared using monomers mentioned above. In particular, it is preferable for the resin dispersant to include a repeating unit having a biphenyl skeleton in an amount not less than 40% by mole. By using such a resin dispersant, steric hindrance effect can be produced and thereby good dispersibility can be imparted to the resultant film forming liquid. The method for manufacturing the resin dispersant is mentioned above.

Weight average molecular weight of a resin can be determined by various methods, but in the present application the weight average molecular weight of a dispersion resin is determined by gel permeation chromatography (GPC).

The content of the dispersion resin in the film forming liquid is preferably from 0.1 to 10% by weight based on the total weight of the liquid.

The acidic carbon black, and a water soluble resin and/or a resin dispersant are dispersed or dissolved in a water soluble organic solvent. The water soluble organic solvent will be explained later.

The film forming liquid preferably includes an organic amine in an amount of from 0.001 to 10% by weight based on the total weight of the liquid.

The content of the organic solvent in the film forming liquid is generally from 60 to 95% by weight, and the content of the binder resin in the film forming liquid is generally from 1 to 40% by weight based on the total weight of the film forming liquid.

The film forming liquid may include additives such as surfactants, antifoaming agents and antiseptic agents.

Suitable surfactants for use in the film forming liquid include anionic surfactants such as fatty acid salts, salts of higher alcohol sulfuric acid esters, salts of liquid aliphatic oil sulfuric acid esters and alkylarylsulfonic acid salts; and nonionic surfactants such as polyoxyethylene alkyl ethers, polyoxyethylene alkyl esters and polyoxyethylenesorbitan alkyl esters. The added amount of the surfactant is changed depending on the surfactant used, but is generally from 0.01 to 5% by weight.

The viscosity, electroconductivity and carbon dispersion state are very important properties of the film forming liquid. Even when a film forming liquid having desired properties is used, there is a case where a desired resultant intermediate transfer medium cannot be produced if the intermediate transfer medium is prepared by a molding method in which the liquid is heated to produce a polyimide resin. This is because the dispersibility of the carbon black in the liquid deteriorates during the molding process.

As a result of the present inventors' investigation, it is found that by using a film forming liquid in which the weight ratio of the carbon black to the water soluble resin (or the resin dispersant) is from 3/1 to 10/1, and preferably from 10/3 to 10/1, the above-mentioned problem caused in the molding process can be avoided even when molding is performed under various conditions. Therefore, an intermediate transfer medium having good resistance uniformity can be provided. Namely, it is found that inclusion of a water soluble resin in the film forming liquid in an excessive amount relative to that of the carbon black adversely affects dispersion of the carbon black in the liquid and crosslinking of the polyimide resin in the molding process.

Specifically, it is found that the content of the dispersion resin (i.e., the water soluble resin and/or the resin dispersant) dissolved in the film forming liquid is preferably not greater than 2% by weight, and more preferably not greater than 1% by weight based on the total weight of the film forming liquid. The dispersion resin dissolved in the film forming liquid means a resin in a state in which the resin is dissolved in the liquid without adsorbed on the pigment (carbon black). In addition, it is found that the content of the total of the carbon black and the dispersion resin is not less than 10% by weight to prepare a film forming liquid in which carbon black is stably dispersed. This is because when the total content falls in this range, dispersion of carbon black is efficiently and properly performed.

Specifically, a typical method for preparing the film forming liquid of the present invention is as follows.

An acidic carbon black and a dispersion resin are mixed with a water soluble organic solvent optionally together with an amine or an alkali. Then the mixture is subjected to a dispersion treatment using a device such as dispersion machines mentioned below to prepare a dispersion. In this regard, the dispersion may include an antifoaming agent, and/or the dispersion may be subjected to a centrifugal treatment to remove coarse particles. The thus prepared dispersion is then mixed with a binder resin and other additives, and the mixture is further subjected to a dispersion treatment. The dispersion is optionally diluted so as to have a desired viscosity. Thus, a film forming liquid is prepared.

In order that the content of the dispersion resin dissolved in the film forming liquid, it is preferable to heat the vehicle including the water soluble organic solvent, dispersion resin and amine (or alkali) at a temperature not lower than 60° C. for 30 minutes or more to completely dissolve the resin in the solvent.

It is preferable that the added amount of the amine (or alkali) is not less than 1.2 times the amount (Wa) determined by the following equation.
Wa(g)=AVr×Mwa×Wr/56000
wherein Wa represent the weight of amine (or alkali) to be added in units of gram; AVr represents the acid value of the dispersion resin; Mwa represents the molecular weight of the amine (or alkali); and Wr represents the weight of the dispersion resin added in units of gram.

In addition, it is preferable that before the mixture of the carbon black, dispersion resin and amine (or alkali) is subjected to a dispersion treatment, the mixture is subjected to a premixing treatment for 30 minutes or more. By performing this premixing treatment, the wettability of the carbon black can be improved and thereby the dispersion resin can be easily adsorbed on the surface of the carbon black.

Suitable amines for use in the film forming liquid include monoethanol amine, diethanol amine, triethanol amine, aminmethylpropanol, ammonia, etc. Suitable alkalis for use in the film forming liquid include inorganic alkalis such as hydrates of alkali metal salts (e.g., sodium hydroxide, potassium hydroxide and lithium hydroxide).

Suitable dispersion machines for use in the dispersion treatment include any known dispersion machines such as ball mills, roll mills and sand mills. Among these dispersing machines, high speed sand mills are preferably used. Specific examples of the commercialized high speed sand mills include SUPER MILL, SAND GRINDER, BEAD MILL, AGITATOR MILL, GRAIN MILL, DYNO MILL, PEARL MILL and COBOL MILL.

In order to prepare a dispersion in which carbon black is dispersed while having a desired particle diameter, it is preferable to use one or more of the following methods:
(1) the size of the dispersing medium (i.e., beads, balls or the like) used for the dispersion machine is decreased;
(2) the filling factor of the dispersing medium in the dispersion machine is increased;
(3) the dispersing time is lengthened;
(4) liquid discharging speed (i.e., quantity of the liquid supplied per unit time) is decreased; and
(5) the resultant dispersion is filtered or subjected to a centrifugal treatment to remove coarse particles.

The amount of the resin dissolved in the dispersion without adsorbed on the carbon black is measured by the following method:
(1) the dispersion is subjected to an ultra-centrifugal treatment to precipitate the pigment (carbon black) and the resin adsorbed on the pigment; and
(2) the amount of the resin included in the supernatant liquid is determined using a total organic carbon (TOC) analyzer or a drying method in which the supernatant liquid is dried to determine the weight of the resin therein.

Then the intermediate transfer medium of the present invention will be explained.

The intermediate transfer medium of the present invention is a semiconductive belt including at least a resin layer, in which a carbon black (i.e., an electroconductive material) is dispersed, on a surface thereof. The intermediate transfer medium may have a single-layer structure of a multi-layer structure.

In general, the primary particle diameter of carbon black is from 10 nm to 1 μm. When being dispersed in a liquid or a resin, carbon black tends to agglomerate. In the intermediate transfer medium of the present invention, it is preferable that carbon black is dispersed therein (or in the polyimide resin) while having a particle diameter of from 10 to 300 nm. When the particle diameter of the carbon black dispersed therein is too large, problems such that the smoothness and resistance uniformity of the resultant intermediate transfer medium deteriorate occur. In addition, another problem which occurs is that the resistance of the intermediate transfer medium decreases with time when electric stresses are repeatedly applied thereto.

In contrast, when the particle diameter is too small, a large amount of carbon black has to be included in the intermediate transfer medium to impart a desired resistance thereto, and thereby the resultant intermediate transfer medium has weak mechanical strength.

The method for preparing the intermediate transfer medium of the present invention will be explained referring to an example using a polyimide resin as the binder resin.

As the carbon black, channel carbon black or furnace carbon black is preferably used. As mentioned above, carbon black is preferably subjected to an oxidation treatment so as to have good dispersibility in solvents. When carbon black is treated to an oxidation reaction, functional groups including an oxygen atom, such as carboxyl groups, ketone groups and hydroxyl groups, are formed on the surface of the carbon black. Therefore, the treated carbon black has good affinity for polar solvents, and in addition the surface thereof is hardly oxidized even when various electric stresses are applied thereto. Therefore, the above-mentioned problem in that the resistance of the intermediate transfer medium decreases with time when electric stresses are repeatedly applied thereto hardly occurs.

At least one carbon black including volatile components in an amount of from 3.5 to 8% is preferably used. Specific examples of such carbon blacks include COLOR BLACK FW200, COLOR BLACK FW2, COLOR BLACK FW2V, COLOR BLACK FW1, COLOR BLACK FW18, SPECIAL BLACK 6, COLOR BLACK S170, COLOR BLACK S160, SPECIAL BLACK 5, SPECIAL BLACK 4, SPECIAL BLACK 4A, PRINTEX 150T, PRINTEX U, PRINTEX V, PRINTEX 140U, PRINTEX 140V, SPECIAL BLACK 550, SPECIAL BLACK 350, SPECIAL BLACK 250, and SPECIAL BLACK 100, which are manufactured by Degussa A.G.; MA7, MA77, MA8, MA11, MA100, MA100R, MA230 and MA220, which are manufactured by Mitsubishi Chemical Corp.; and MONARCH 700, MONARCH 800, MONARCH 900, MONARCH 1000, MONARCH 1300, MONARCH 1400, MOGUL-L, REGAL 400R and VULCAN XC-72R, which are manufactured Cabot Co.; etc.

It is preferable that carbon black dispersed in the intermediate transfer medium has an average particle diameter of from 10 to 300 nm. The primary particle diameter of the carbon black is preferably from 5 to 100 nm and more preferably from 10 to 70 nm. When the primary particle diameter is too large, it is hard to prepare a good intermediate transfer medium in view of surface smoothness, mechanical strength, and electric resistance uniformity.

The average particle diameter and primary particle diameter of carbon black can be determined using an electronic microscope.

In order to control the resistivity of the intermediate transfer medium, the carbon black may be subjected to a grafting treatment so that a polymer such as polystyrene and polymethyl methacrylate is grafted on the surface thereof or a treatment in which the surface is covered with an insulating material. In addition, it is preferable to subject the carbon black to an oxidizing treatment.

This example of the intermediate transfer medium includes a polyimide resin as the binder resin.

As mentioned above, polyimide resins are prepared by heating a polyamide acid solution including carbon black to convert the polyamide acid to a polyimide while removing the solvent. Any known polyimide resins can be used for the intermediate transfer medium of the present invention. Polyimide resins are typically prepared by subjecting an acid dihydride and a diamine to a polymerization reaction. Among the polyimide resins, aromatic polyimide resins are preferably used because of having good combination of mechanical strength, heat resistance and dimension stability.

Specific examples of the acid dianhydride for use in preparing the polyimide resin include pyromellitic acid dianhydride, 3,3′,4,4′-benzophenonetetracarboxylic acid dianhydride, 3,3′,4,4′-biphenyltetracarboxylic acid dianhydride, 2,3,3′,4-biphenyltetracarboxylic acid dianhydride, 2,3,6,7-naphthalenetetracarboxylic acid dianhydride, 1,2,5,6-naphthalenetetracarboxylic acid dianhydride, 1,4,5,8-naphthalenetetracarboxylic acid dianhydride, 2,2-bis(3,4-dicarboxyphenoxy)propane dianhydride, bis(3,4-dicarboxyphenyl)sulfone dianhydride, perylene-3,4,9,10-tetracarboxylic acid dianhydride, bis(3,4-dicarboxyphenyl)ether dianhydride, ethylenetetracarboxylic acid dianhydride, etc.

Specific examples of the diamine for use in preparing the polyimide resin include 4,4′-diaminodiphenyl ether, 4,4′-diaminodiphenyl methane, 3,3′-dichlorobenzidine, 4,4′-diaminodiphenylsulfide, 3,3′-diaminodiphenylsulfone, 1,5-diaminohaphthalene, m-phenylenediamine, p-phenylenediamine, 3,3′-dimethyl-4,4′-biphenyldiamine, benzidine, 3,3′-dimethylbenzidine, 3,3′-dimethoxylbenzidine, 4,4′-diaminodiphenylsulfone, 4,4′-diaminodiphenylsulfide, 4,4′-diaminodiphenylpropane, 2,4-bis(β-amino-t-butyl)toluene, bis (p-β-amino-t-butylphenyl)ether, bis (p-β-methyl-δ-aminophenyl)benzene, bis-p-(1,1-dimethyl-5-aminopentyl)benzene, 1-ispropyl-2,4-m-phenylenediamine, m-xylenediamine, p-xylenediamine, di(p-aminocyclohexyl)methane, hexamethylenediamine, heptamethylenediamine, octamethylenediamine, nonamethylenediamine, decamethylenediamine, diaminopropyltetramethylene, 3-methylheptamethylenediamine, 4,4-dimethylheptamethylenediamine, 2,11-diaminododecane, 1,2-bis-3-aminopropoxyethane, 2,2-dimethylpropylenediamine, 3-methoxyhexamethylenediamine, 2,5-dimethylheptamethylenediamine, 3-methylheptamethylenediamine, 5-methylnonamethylenediamine, 2,17-diaminoeicosadecane, 1,4-diaminocyclohexane, 1,10-diamino-1,10-dimethyldecane, 1,1,2-diaminooctadecane, 2,2-bis[4-(4-aminophenoxy)phenyl]propane, piperazine, H₂N(CH₂)₃O(CH₂)₂OCH₂NH₂, H₂N(CH₂)₃S(CH₂)₃NH₂, H₂N(CH₂)₃(CH₂)₂(CH₂)₃NH₂, etc.

The polyamide acid solution including carbon black for use in preparing the polyimide resin is typically prepared by the following method. At first, one or more acid dianhydrides and one or more diamines are dissolved in a polar organic solvent. The mixture is subjected to a polymerization reaction to prepare a polyamide acid solution. A carbon black is added to the thus prepared polyamide acid solution to prepare the polyamide acid solution including carbon black. Alternatively, a method in which a carbon black is previously dispersed in a polar organic solvent, and then the mixture is mixed with one or more diamines and one or more acid anhydrides, followed by polymerization reaction can also be used.

Suitable solvents for use in polyamide acid solution include N,N-dialkylamide compounds. Specific examples thereof include N,N-dimethylformaide, N,N-dimethylacetamide, etc. These solvent can be easily removed from the polyamide acid solution or molding by a method such as evaporation, substitution, and diffusion. In addition, one or more other polar solvents such as N,N-diethylformaide, N,N-diethylacetamide, N,N-dimethylmethoxyacetamide, dimethylsulfoxide, hexamethylphosphorotriamide,N-methyl-2-pyrrolidone, pyridine, tetramethylsulfone, dimethyltetramethylenesulfone, etc., can also be used together with the above-mentioned solvents.

In addition, one or more other solvents such as phenolic solvents (e.g., cresol, phenol, and xylenol); benzonitrile, dioxane, butyrolactone, xylene, cyclohexane, hexane, benzene, and toluene can also be used together with the polar solvents. However, it is preferable to prevent water from being included in the reaction system to prevent decrease in the molecular weight of the resultant polyamide acid due to hydrolysis thereof.

In order to improve the affinity of carbon black for polar organic solvents, dispersants can be added to the dispersion. Suitable dispersants include polymer dispersants. Specific examples thereof include poly(N-vinyl-2-pyrrolidone), poly(N,N-diethylacrylamide), poly(N-vinylformaide), poly(N-vinylacetamide), poly(N-vinylphthalamide), poly(N-vinylsuccinic acid amide), poly(N-vinyl urea), poly(N-vinyl piperidone), poly(N-vinylcaprolactam), poly(N-vinyloxazoline), etc.

In addition, dispersion stabilizers such as resins, surfactants and inorganic salts can also be used in such an amount not to deteriorate the desired properties of the resultant polyamide acid.

Then an embodiment of the method for preparing an intermediate endless belt will be explained.

At first, one or more carbon blacks and a dispersion resin are added to a polar organic solvent and the carbon black is dispersed by a known dispersing method using a dispersion machine such as ball mills, sand mills, basket mills, and supersonic dispersion machines, to prepare a carbon black dispersion. Then one or more acid dianhydrides and one or more diamines are added to the carbon dispersion. The mixture is subjected to a polymerization reaction while agitated. Thus, a polyamide acid solution is prepared.

The mixing ratio of the raw materials are determined depending on the target properties (such as surface resistivity) of the resultant intermediate transfer medium. For example, in order to prepare an intermediate transfer medium having a surface resistivity of from 1×10⁸ to 1×10¹³ Ω/□ (hereinafter this resistivity is represented as 8 to 13 log Ω/□ in logarithmic form), and preferably from 8 to 12 log Ω/□, the content of the carbon black in the resultant polyimide resin is preferably from 10 to 40% by weight, and more preferably from 13 to 30% by weight, based on the weight of the polyimide resin. When the carbon content is too low, the desired resistivity cannot be obtained. In this case, if a carbon black having a high conductivity is used to obtain the desired resistivity, it is difficult to stably produce an intermediate transfer medium having a uniform resistivity. In contrast, when the carbon content is too high, the mechanical strength of the resultant polyimide film deteriorates. Therefore, a problem which occurs is that the intermediate transfer medium is cracked when rotated by driving rollers while stretched.

The concentration of the monomers (i.e., acid dianhydride compounds and diamine compounds) in the dispersion is preferably from 5 to 30% by weight. In addition, the polymerization reaction is preferably performed under nitrogen gas flow. The reaction temperature is preferably not higher than 80° C. and the reaction time is preferably from 0.5 to 10 hours. Since the viscosity of the polyamide acid solution increases as reaction proceeds, it is preferable to add a solvent to control (decrease) the viscosity. The viscosity is preferably from 1 to 1000 Pa·s.

The thus prepared polyamide acid solution is heated to remove the solvent and to change the polyamide acid to the polyimide. Thus, the polyimide resin composition for use in the present invention is prepared. In this case, the heating temperature is not particularly limited, and is set to a temperature at which the solvent can be evaporated. However, when the heating temperature is too high, the solvent is rapidly evaporated, thereby forming small voids in the resultant polyimide resin layer. Therefore, the heating temperature is preferably not higher than 230° C. When the temperature is too low, it takes a long time to evaporate the solvent. Therefore, the heating temperature is preferably not lower than 80° C. The heating time is determined depending on the heating temperature, and is generally from 10 to 60 minutes.

Then the composition is further heated to complete the polyimide conversion reaction and to remove the water generated due to formation of rings. In this case, the heating temperature is generally from the solvent removing temperature to 450° C., and preferably from 250 to 400° C. The heating time is preferably from 10 to 60 minutes.

Next, the intermediate transfer medium will be explained. Specific examples of the molding method for forming an intermediate transfer belt using the thus prepared polyimide resin compound include known molding methods. For example, a typical method for forming a thin layer such as films or belts is as follows:
(1) the polyamide acid solution is coated on a plate (such as copper plates); and
(2) the coated layer is heated to remove the solvent, to convert the polyamide acid to a polyimide resin and to remove the water generated due to formation of rings, resulting in formation of a film or a belt of the polyimide resin composition.

In order to form an endless belt, (1) a method in which the polyamide acid solution is flow-casted or coated on an inner surface of a cylindrical die; the cylindrical die is rotated to from an endless film; and then the film is heated to remove the solvent, to convert the polyamide acid to a polyimide resin and to remove the water generated due to formation of rings, resulting in formation of an endless belt of the polyimide resin composition. The endless film can be prepared by a method in which a bullet-form material is moved through the polyamide acid solution by its own weight or upon application of pressure; or a method in which a cylinder is dipped in the polyamide acid solution and then the cylinder is pulled up, followed by molding using a ring-form die.

The film, belt and endless belt can have two or more layers. In this case, at least the outermost layer is the polyimide resin layer.

In the present invention, polymer-grafted carbon blacks can be used as the carbon black. Polymer-grafted carbon blacks mean carbon black particles, which are primary particles of carbon black or aggregates of a few primary particles of carbon and on the surface of which a polymer is grafted. When a polymer is grafted on the carbon black, an addition reaction such as electrophilic addition reactions, radical addition reactions and nucleophilic addition reactions can be used therefor.

Carbon black generally has a primary particle diameter of from few nanometer to few hundred nanometer. However, carbon black has a large cohesive force, and therefore carbon black is typically aggregates of primary carbon black particles, which have a particle diameter of few micrometer. The cohesive force between carbon black particles is much greater than the affinity of a carbon black particle for another material such as a resin. Therefore, it is very difficult to disperse carbon black particles in a resin such that the dispersed carbon black particles have a particle diameter on the order of submicron. Therefore, an intermediate transfer medium having a resistance uniformity cannot be prepared.

In contrast, polymer-grafted carbon black has a structure such that a polymer invades the interfaces between carbon black particles, and therefore the cohesive force between the carbon black particles can be decreased. In this case, when the polymer has good affinity for the resin material used for the intermediate transfer medium, the polymer-grafted carbon black can be dispersed in the resin material on the order of submicron.

However, even when the polymer grafted on the carbon black has good affinity for the resin material, the resultant intermediate transfer medium does not have good resistance uniformity if the polymer is not effectively grafted on the carbon black particles. In this case, if the content of the polymer is increased to improve the affinity of the carbon black, a problem in that the resultant polymer-grafted carbon black has low electroconductivity occurs.

The above-mentioned problems can be solved by polymer-grafted carbon blacks in which a polymer having a reactivity with a carbon black is grafted on the carbon black. Specifically a polymer having a group which can be reacted with a functional group present on the surface of the carbon black is used as the graft polymer.

In order to secure grafting of a polymer on the surface of a carbon black, the polymer and the carbon black are preferably connected with each other by covalent bonding. Specific examples of such bonding include ester bonding, thioester bonding, amide bonding, amino bonding, ether bonding, thioether bonding, carbonyl bonding, thiocarbonyl bonding and sulfonyl bonding. Among these bondings, ester bonding, thioester bonding and amide bonding. From this point of view, the reaction groups are preferably epoxy groups, thioepoxy groups, aziridine, and oxazoline are preferable. The reaction groups are not limited thereto, but when another reaction group is used, the carbon black used for forming polymer-grafted carbon black is limited. When the above-mentioned reaction groups are used, the addition reaction between the polymer and the carbon black can be easily performed at a high grafting rate even under moderate reaction conditions. In particular, it is preferable that carbon black has a carboxyl group on the surface thereof, because the carboxyl group can be irreversibly addition-reacted with an epoxy group, a thioepoxy group, an aziridine group or an oxazoline group at a high yield, resulting information of a covalent bonding between the carbon black and the polymer.

Having generally described this invention, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

Properties of the carbon blacks used for Examples and Comparative Examples are shown in Table 3.

TABLE 3

| | | | | Volatile | |
|---|---|---|---|---|---|
| | Average | Specific | | component | |
| | Particle | surface | DBP oil | content | |
| | Diameter | area | absorption | (% by | |
| Name | (nm) | (m²/g) | (ml/100 g) | weight) | PH |
| COLOR | 17 | 200 | 150 | 4.5 | 4.0 |
| BLACK | | | | | |
| S170 | | | | | |
| PRINTEX U | 25 | 100 | 115 | 5.0 | 4.5 |
| COLOR | 13 | 320 | 170 | 6.0 | 4.0 |
| BLACK FW1 | | | | | |
| MOGUL L | 24 | 138 | 60 | 5.0 | 3.4 |
| PRINTEX V | 25 | 100 | 115 | 5.0 | 4.5 |
| REGAL | 24 | 112 | 65 | 1.0 | 7.5 |
| 660R | | | | | |
| MA100 | 22 | 134 | 100 | 1.5 | 3.5 |
| SPECIAL | 17 | 300 | 160 | 18.0 | 2.5 |
| BLACK 6 | | | | | |
| RAVEN | 26 | 120 | 60 | 3.0 | 5.5 |
| 1040 | | | | | |
| #2400B | 15 | 260 | 45 | 10.0 | 2.0 |
| COLOR | 15 | 260 | 160 | 5.0 | 4.5 |
| BLACK | | | | | |
| FW18 | | | | | |
| COLOR | 20 | 150 | 150 | 5.0 | 4.5 |
| BLACK | | | | | |
| S160 | | | | | |
| PRINTEX | 29 | 90 | 115 | 5.0 | 4.5 |
| 140U | | | | | |
| PRINTEX | 29 | 90 | 110 | 5.0 | 4.5 |
| 140V | | | | | |
| REGAL | 25 | 96 | 69 | 3.5 | — |
| 400R | | | | | |

1. Examples and Comparative Examples Using Carbon Black dispersed in resin

### Example 1

Preparation of Pigment Dispersion

The following components were mixed and the mixture was heated to 70° C. using a water bath, to perfectly dissolve the resin in the solvent.

| | |
|---|---|
| Styrene - acrylic acid - butyl acrylate copolymer | 3 parts |
| (acid value of 60 mgKOH/g, weight average molecular weight | |
| of 13,000) | |
| Monoethanol amine | 2 parts |
| N-methyl pyrrolidone | 81 parts |

Then 14 parts by weight of a carbon black (COLOR BLACK S170 from Degussa A.G.) were added to the resin solution, and the mixture was subjected to a pre-mixing treatment for 30 minutes. Then the mixture was subjected to a dispersion treatment, the conditions of which are as follows:

| | |
|---|---|
| Dispersing machine: | SAND GRINDER (from Igarashi |
| | Machine Manufacturing Co., Ltd.) |
| Dispersing medium: | zirconia beads with a particle |
| | diameter of 1 mm |
| Filling factor of dispersing medium: | 50% |
| Dispersion time: | 3 hours |

Further, the dispersion was subjected to a centrifugal treatment for 20 minutes at 12,000 rpm, to remove coarse particles.

Preparation of Film Forming Liquid (A)

The following components were mixed to prepare a film forming liquid (A).

| | | |
|---|---|---|
| Pigment dispersion prepared above | 25 | parts |
| N-methyl pyrrolidone | 8 | parts |
| Polyimide resin (hard type) | 33 | parts |
| | | (solid: 6 parts) |
| Polyimide resin (soft type) | 33 | parts |
| | | (solid: 6 parts) |
| Silicone-based leveling agent | 0.01 | parts |

In this film forming liquid (A), the weight ratio of the pigment (carbon black) to the water soluble resin (styrene-acrylic acid-butyl acrylate copolymer) is 14/3.

### Example 2

Preparation of Pigment Dispersion

The following components were mixed and the mixture was heated to 70° C. using a water bath, to perfectly dissolve the resin in the solvent.

| | |
|---|---|
| Styrene - maleic acid half ester - | 6 parts |
| maleic anhydride copolymer | |
| (acid value of 188 mgKOH/g, weight average | |
| molecular weight of 15,000) | |
| Triethanol amine | 4 parts |
| N-methyl pyrrolidone | 70 parts |

Then 20 parts by weight of a carbon black (PRINTEX U from Degussa A.G.) were added to the resin solution, and the mixture was subjected to a pre-mixing treatment for 30 minutes. Then the mixture was subjected to a dispersion treatment, the conditions of which are as follows:

| | |
|---|---|
| Dispersing machine: | PEARL MILL (from Ashizawa |
| | Finetech Co., Ltd.) |
| Dispersing medium: | glass beads with a |
| | particle diameter of 1 mm |
| Filling factor of dispersing medium: | 50% |
| Liquid treating speed: | 100 ml/min |

Further, the dispersion was subjected to a centrifugal treatment for 20 minutes at 12,000 rpm, to remove coarse particles.

Preparation of Film Forming Liquid (B)

The following components were mixed to prepare a film forming liquid (B).

| | | |
|---|---|---|
| Pigment dispersion prepared above | 20 | parts |
| N-methyl pyrrolidone | 6 | parts |
| Polyimide resin (hard type) | 37 | parts |
| | | (solid: 6.5 parts) |
| Polyimide resin (soft type) | 37 | parts |
| | | (solid: 6.5 parts) |
| Silicone-based leveling agent | 0.01 | parts |

In this film forming liquid (B), the weight ratio of the pigment (carbon black) to the water soluble resin (styrene-maleic acid half ester-maleic anhydride copolymer) is 10/3.

### Example 3

Preparation of Pigment Dispersion

The following components were mixed and the mixture was heated to 70° C. using a water bath, to perfectly dissolve the resin in the solvent.

| | |
|---|---|
| Styrene - acrylic acid - butyl acrylate | 5 parts |
| copolymer | |
| (acid value of 80 mgKOH/g, weight average | |
| molecular weight of 6700) | |
| Aminomethyl propanol | 2 parts |
| N-methyl pyrrolidone | 73 parts |

Then 20 parts by weight of a carbon black (COLOR BLACK FW1 from Degussa A.G.) were added to the resin solution, and the mixture was subjected to a pre-mixing treatment for 30 minutes. Then the mixture was subjected to a dispersion treatment, the conditions of which are as follows:

| | |
|---|---|
| Dispersing machine: | PEARL MILL (from Ashizawa |
| | Finetech Co., Ltd.) |
| Dispersing medium: | glass beads with a |
| | particle diameter of 1 mm |
| Filling factor of dispersing medium: | 50% |
| Liquid treating speed: | 100 ml/min |

Further, the dispersion was subjected to a centrifugal treatment for 20 minutes at 12000 rpm, to remove coarse particles.

Preparation of Film Forming Liquid (C)

The following components were mixed to prepare a film forming liquid (C).

| | | |
|---|---|---|
| Pigment dispersion prepared above | 20 | parts |
| N-methyl pyrrolidone | 6 | parts |
| Polyimide resin (hard type) | 37 | parts |
| | | (solid: 6.5 parts) |
| Polyimide resin (soft type) | 37 | parts |
| | | (solid: 6.5 parts) |
| Silicone-based leveling agent | 0.01 | parts |

In this film forming liquid (C), the weight ratio of the pigment (carbon black) to the water soluble resin (styrene-acrylic acid-butyl acrylate copolymer) is 4/1.

### Example 4

Preparation of Pigment Dispersion

The following components were mixed and the mixture was heated to 70° C. using a water bath, to perfectly dissolve the resin in the solvent.

| | |
|---|---|
| Styrene - maleic acid half ester - | 5 parts |
| maleic anhydride copolymer | |
| (acid value of 188 mgKOH/g, weight average | |
| molecular weight of 15000) | |
| Triethanol amine | 3 parts |
| N-methyl pyrrolidone | 77 parts |

Then 20 parts by weight of a carbon black (MOGUL L from Cabot Co.) were added to the resin solution, and the mixture was subjected to a pre-mixing treatment for 30 minutes. Then the mixture was subjected to a dispersion treatment, the conditions of which are as follows:

| | |
|---|---|
| Dispersing machine: | SAND GRINDER (from Igarashi |
| | Machine Manufacturing Co., Ltd.) |
| Dispersing medium: | zirconia beads with a |
| | particle diameter of 1 mm |
| Filling factor of dispersing medium: | 50% |
| Dispersion time: | 3 hours |

Further, the dispersion was subjected to a centrifugal treatment for 20 minutes at 12000 rpm, to remove coarse particles.

Preparation of Film Forming Liquid (D)

The following components were mixed to prepare a film forming liquid (D).

| | | |
|---|---|---|
| Pigment dispersion prepared above | 25 | parts |
| N-methyl pyrrolidone | 6 | parts |
| Polyimide resin (hard type) | 35 | parts |
| | | (solid: 6.3 parts) |
| Polyimide resin (soft type) | 35 | parts |
| | | (solid: 6.3 parts) |
| Silicone-based leveling agent | 0.01 | parts |

In this film forming liquid (D), the weight ratio of the pigment (carbon black) to the water soluble resin (styrene-maleic acid half ester-maleic anhydride copolymer) is 3/1.

### Example 5

The procedure for preparation of the film forming liquid (A) in Example 1 was repeated except that the carbon black was replaced with PRINTEX V from Degussa A.G. Thus, a film forming liquid (E) was prepared.

In this film forming liquid (E), the weight ratio of the pigment (carbon black) to the water soluble resin (styrene-acrylic acid-butyl acrylate copolymer) is 14/3.

### Comparative Example 1

The procedure for preparation of the film forming liquid (A) in Example 1 was repeated except that the carbon black was replaced with MA100 from Mitsubishi Chemical Corp. Thus, a film forming liquid (F) was prepared.

In this film forming liquid (F), the weight ratio of the pigment (carbon black) to the water soluble resin (styrene-acrylic acid-butyl acrylate copolymer) is 14/3.

### Comparative Example 2

The procedure for preparation of the film forming liquid (A) in Example 1 was repeated except that the added amounts of the styrene-acrylic acid-butyl acrylate copolymer, monoethanol amine, and N-methylpyrrolidone were changed to 14 parts, 9.3 parts and 62.7 parts, respectively. Thus, a film forming liquid (G) was prepared.

In this film forming liquid (G), the weight ratio of the pigment (carbon black) to the water soluble resin (styrene-acrylic acid-butyl acrylate copolymer) is 1/1.

### Comparative Example 3

The procedure for preparation of the film forming liquid (C) in Example 3 was repeated except that the water soluble resin was replaced with a styrene-acrylic resin-butyl acrylate copolymer having a weight average molecular weight of 2,800 and an acid value of 115 mgKOH/g. Thus, a film forming liquid (H) was prepared.

In this film forming liquid (H), the weight ratio of the pigment (carbon black) to the water soluble resin (styrene-acrylic acid-butyl acrylate copolymer) is 10/3.

### Comparative Example 4

The procedure for preparation of the film forming liquid (B) in Example 2 was repeated except that the carbon black was replaced with SPECIAL BLACK 6 from Degussa A.G. Thus, a film forming liquid (I) was prepared.

In this film forming liquid (I), the weight ratio of the pigment (carbon black) to the water soluble resin (styrene-maleic acid half ester-maleic anhydride copolymer) is 10/3.

### Comparative Example 5

The procedure for preparation of the film forming liquid (D) in Example 4 was repeated except that the carbon black was replaced with RAVEN 1040 from Columbian Carbon Co. Thus, a film forming liquid (J) was prepared.

In this film forming liquid (J), the weight ratio of the pigment (carbon black) to the water soluble resin (styrene-maleic acid half ester-maleic anhydride copolymer) is 3/1.

### Comparative Example 6

The procedure for preparation of the film forming liquid (A) in Example 1 was repeated except that the carbon black was replaced with #2400B from Mitsubishi Chemical Corp. Thus, a film forming liquid (K) was prepared.

In this film forming liquid (K), the weight ratio of the pigment (carbon black) to the water soluble resin (styrene-acrylic acid-butyl acrylate copolymer) is 14/3.

### Comparative Example 7

The procedure for preparation of the film forming liquid (A) in Example 1 was repeated except that the formula of the pigment dispersion is as follows.

| | |
|---|---|
| Styrene - acrylic acid - butyl acrylate copolymer | 1 parts |
| (acid value of 60 mgKOH/g, weight average | |
| molecular weight of 13000) | |
| Monoethanol amine | 1 parts |
| N-methyl pyrrolidone | 84 parts |

Thus, a film forming liquid (L) was prepared.

In this film forming liquid (L), the weight ratio of the pigment (carbon black) to the water soluble resin (styrene-acrylic acid-butyl acrylate copolymer) is 14/1.

2. Examples and Comparative Examples Using Polymer-Grafted Carbon Black

### Synthesis Example 1

The following components were mixed to prepare a monomer composition liquid (1).

| | |
|---|---|
| Polymethyl methacrylate macromer | 75 parts |
| (AA-6 from Toagosei Co., Ltd.) | |
| Styrene monomer (St) | 15 parts |
| Isopropenyloxazoline (IPO) | 10 parts |
| Azobisisobutyronitrile (AIBN) | 3 parts |
| (Initiator) | |
| Propyleneglycol monomethyl ether acetate | 100 parts |
| (PGM-Ac) | |

On the other hand, 50 parts of PGM-Ac were contained in a separable flask equipped with a stirrer, a nitrogen feeding tube, a thermometer, and a funnel, and then heated to 80° C. The above-prepared monomer composition liquid (1) was set in the funnel to be added into the PGM-Ac in 3 hours while the temperature of the mixture was maintained at 80° C., to perform a polymerization reaction. Further, the polymerization reaction was continued for 2 hours at 80° C. Then the temperature of reaction product was raised to 120° C. and aged for 2 hours, followed by cooling. Thus a polymer solution (1) having a solid content of 40% was prepared.

### Synthesis Example 2

The procedure for preparation of the polymer solution (1) in Synthesis Example 1 was repeated except that the macromer (AA-6) was replaced with a methylmethacrylate-hydroxyethyl methacrylate macromer (AA-714 from Toagosei Co., Ltd.). Thus, a polymer solution (2) having a solid content of 40% was prepared.

### Synthesis Example 3

The following components were mixed.

| | |
|---|---|
| Methacryloyl isocyanate | 8.9 parts |
| (molecular weight of 111.1) | |
| PGM-Ac | 13.35 parts |

The mixture was added into 250 parts of the polymer solution (2) prepared above in 30 minutes. Thus, a polymer solution (3) including a polymer having a double bond and having a solid content of 40% was prepared.

### Synthesis Example 4

The following components were contained in a separable flask equipped with a thermometer, an agitator, and a condenser.

| | |
|---|---|
| Carbon black | 30 parts |
| (COLOR BLACK FW18 from Degussa A.G.) | |
| Polymer solution (1) prepared above | 22.5 parts |
| PGM-Ac | 97.5 parts |

The mixture was agitated. Then 800 parts of zirconia beads were added into the flask. The mixture was dispersed for 2 hours at 100° C. while agitated at a revolution of 300 rpm to perform a grafting reaction. Then the reaction product was separated from the zirconia beads to prepare a polymer-grafted carbon black dispersion (1). The weight ratio of the carbon black to the water soluble resin in the dispersion (1) was 10/3.

### Synthesis Example 5

The procedure for preparation of the polymer-grafted carbon black dispersion (1) in Synthesis Example 4 was repeated except that the carbon black (COLOR BLACK FW18) was replaced with a carbon black (COLOR BLACK S160 from Degussa A.G.), and the added amounts of the polymer solution (1) and the PGM-Ac were changed from 22.5 parts to 25 parts and from 97.5 parts to 90 parts, respectively. Thus, a polymer-grafted carbon black dispersion (2) was prepared. The weight ratio of the carbon black to the water soluble resin in the dispersion (2) was 3/1.

### Synthesis Example 6

The procedure for preparation of the polymer-grafted carbon black dispersion (1) in Synthesis Example 4 was repeated except that the carbon black (COLOR BLACK FW18) was replaced with a carbon black (REGAL 400R from Cabot Co.). Thus, a polymer-grafted carbon black dispersion (3) was prepared. The weight ratio of the carbon black to the water soluble resin in the dispersion (3) was 10/3.

### Synthesis Example 7

The procedure for preparation of the polymer-grafted carbon black dispersion (1) in Synthesis Example 4 was repeated except that the carbon black (COLOR BLACK FW18) was replaced with a carbon black (PRINTEX 140U from Degussa A.G.), the polymer solution (1) was replaced with 25 parts of the polymer solution (2) and the added amount of the PGM-Ac was changed from 97.5 parts to 82.5 parts. Thus, a polymer-grafted carbon black dispersion (4) was prepared. The weight ratio of the carbon black to the water soluble resin in the dispersion (4) was 3/1.

### Synthesis Example 8

The procedure for preparation of the polymer-grafted carbon black dispersion (1) in Synthesis Example 4 was repeated except that the carbon black (COLOR BLACK FW18) was replaced with a carbon black (PRINTEX 140V from Degussa A.G.), and the polymer solution (1) was replaced with the polymer solution (3). Thus, a polymer-grafted carbon black dispersion (5) was prepared. The weight ratio of the carbon black to the water soluble resin in the dispersion (5) was 10/3.

### Example 6

The following components were mixed to prepare a film forming liquid (M).

| | | |
|---|---|---|
| Polymer-grafted carbon black dispersion (1) | 20 | parts |
| N-methylpyrrolidone | 6 | parts |
| Polyimide (hard type) | 37 | parts |
| | | (solid: 6.5 parts) |
| Polyimide (soft type) | 37 | parts |
| | | (solid: 6.5 parts) |
| Silicone-based leveling agent | 0.01 | parts |

### Example 7

The following components were mixed to prepare a film forming liquid (N).

| | | |
|---|---|---|
| Polymer-grafted carbon black dispersion (2) | 20 | parts |
| N-methylpyrrolidone | 2 | parts |
| Polyimide (hard type) | 39 | parts |
| | | (solid: 7 parts) |
| Polyimide (soft type) | 39 | parts |
| | | (solid: 7 parts) |
| Silicone-based leveling agent | 0.01 | parts |

### Example 8

The following components were mixed to prepare a film forming liquid (O).

| | | |
|---|---|---|
| Polymer-grafted carbon black dispersion (3) | 20 | parts |
| N-methylpyrrolidone | 6 | parts |
| Polyimide (hard type) | 37 | parts |
| | | (solid: 6.5 parts) |
| Polyimide (soft type) | 37 | parts |
| | | (solid: 6.5 parts) |
| Silicone-based leveling agent | 0.01 | parts |

### Example 9

The following components were mixed to prepare a film forming liquid (P).

| | | |
|---|---|---|
| Polymer-grafted carbon black dispersion (4) | 20 | parts |
| Polyimide (hard type) | 40 | parts |
| | | (solid: 7.3 parts) |
| Polyimide (soft type) | 40 | parts |
| | | (solid: 7.3 parts) |
| Silicone-based leveling agent | 0.01 | parts |

### Example 10

The following components were mixed to prepare a film forming liquid (O).

| | | |
|---|---|---|
| Polymer-grafted carbon black dispersion (5) | 20 | parts |
| N-methylpyrrolidone | 6 | parts |
| Polyimide (hard type) | 37 | parts |
| | | (solid: 6.5 parts) |
| Polyimide (soft type) | 37 | parts |
| | | (solid: 6.5 parts) |
| Silicone-based leveling agent | 0.01 | part |

### Comparative Example 8

The procedure for preparation of the polymer-grafted carbon black dispersion (1) in Synthesis Example 4 was repeated except that the added amounts of the polymer solution (1) and the PGM-Ac were changed from 22.5 parts to 30 parts and from 97.5 parts to 90 parts, respectively. Thus, a polymer-grafted carbon black dispersion (6) including the polymer-grafted carbon black (6) was prepared. The weight ratio of the carbon black to the water soluble resin in the dispersion (6) was 10/4.

The following components were mixed to prepare a film forming liquid (R).

| | | |
|---|---|---|
| Polymer-grafted carbon black dispersion (6) | 20 | parts |
| N-methylpyrrolidone | 6 | parts |
| Polyimide (hard type) | 37 | parts |
| | | (solid: 6.5 parts) |
| Polyimide (soft type) | 37 | parts |
| | | (solid: 6.5 parts) |
| Silicone-based leveling agent | 0.01 | part |

### Comparative Example 9

The procedure for preparation of the polymer-grafted carbon black dispersion (1) in Synthesis Example 4 was repeated except that the polymer solution (1) was replaced with 37.5 parts of the polymer solution (2) and the added amount of the PGM-Ac were changed from 97.5 parts to 82.5 parts. Thus, a polymer-grafted carbon black dispersion (7) including the polymer-grafted carbon black (7) was prepared. The weight ratio of the carbon black to the water soluble resin in the dispersion (7) was 2/1.

The following components were mixed to prepare a film forming liquid (S).

| | | |
|---|---|---|
| Polymer-grafted carbon black dispersion (7) | 20 | parts |
| N-methylpyrrolidone | 6 | parts |
| Polyimide (hard type) | 37 | parts |
| | | (solid: 6.5 parts) |
| Polyimide (soft type) | 37 | parts |
| | | (solid: 6.5 parts) |
| Silicone-based leveling agent | 0.01 | part |

### Comparative Example 10

The procedure for preparation of the polymer-grafted carbon black dispersion (1) in Synthesis Example 4 was repeated except that the polymer solution (1) was replaced with 30 parts of the polymer solution (3). Thus, a polymer-grafted carbon black dispersion (8) including the polymer-grafted carbon black (8) was prepared. The weight ratio of the carbon black to the water soluble resin in the dispersion (8) was 2/1.

The following components were mixed to prepare a film forming liquid (T).

| | | |
|---|---|---|
| Polymer-grafted carbon black dispersion (8) | 20 | parts |
| N-methylpyrrolidone | 6 | parts |
| Polyimide (hard type) | 37 | parts |
| | | (solid: 6.5 parts) |
| Polyimide (soft type) | 37 | parts |
| | | (solid: 6.5 parts) |
| Silicone-based leveling agent | 0.01 | part |

3. Examples and Comparative Examples Using Capsuled Carbon Black

Suitable capsuled carbon blacks include carbon black materials in which a particulate resin such as acrylic resins and polyester resins impregnated with a carbon black, i.e., carbon black materials in which a carbon black is present on the surface, the inside or the entire of a particulate resin. More specifically, carbon black particles manufactured by the method disclosed in JP-A 2000-53898 are preferably used. One example thereof is the following.

Preparation of Capsuled Carbon Black Dispersion (1)

The following components were contained in a reaction vessel equipped with a stirrer, a condenser, and a nitrogen feeding tube while the air was substituted with a nitrogen gas.

| | |
|---|---|
| Methyl ethyl ketone (solvent) | 20 parts |
| Methyl methacrylate (monomer) | 12.8 parts |
| 2-hydroxyethyl methacrylate (monomer) | 1.2 parts |
| Methacrylic acid (monomer) | 2.9 parts |
| Silicone macromer | 2 parts |
| (EM-0711 from Chisso Corp.) | |
| Styrene - acrylonitrile macromer | 1 part |
| (AN-6 from Toagosei Co., Ltd.) | |
| Mercaptoethanol | 0.3 parts |
| (polymer chain transfer agent) | |

Under nitrogen gas flow, the mixture in the reaction vessel was heated to 65° C. while agitated.

On the other hand, the following components were mixed under nitrogen gas flow.

| | |
|---|---|
| Methyl ethyl ketone (solvent) | 60 parts |
| Methyl methacrylate (monomer) | 51 parts |
| 2-hydroxyethyl methacrylate (monomer) | 4.2 parts |
| Methacrylic acid (monomer) | 11 parts |
| Silicone macromer | 8 parts |
| (FM-0711 from Chisso Corp.) | |
| Styrene - acrylonitrile macromer | 4 part |
| (AN-6 from Toagosei Co., Ltd.) | |
| Mercaptoethanol | 1.2 parts |
| (polymer chain transfer agent) | |
| 2,2′-azobis(2,4-dimethylvaleronitrile) | 0.2 parts |

This mixture was gradually dropped into the above-mentioned reaction vessel in 3 hours.

Two hours after completion of the dropping, a solution which had been prepared by dissolving 0.1 parts of 2,2′-azobis(2,4-dimethylvaleronitrile) in 5 parts of methyl ethyl ketone were added into the reaction vessel, and the mixture was aged for 2 hours at 65° C., followed by aging for 2 hours at 70° C. Thus, a vinyl polymer solution was prepared.

A part of the vinyl polymer solution was heated for 2 hours at 105° C. under a reduced pressure to obtain the solid vinyl polymer. It was confirmed that the solid polymer has a weight average molecular weight of about 10,000 and a glass transition temperature of 180° C.

Then 3 g of the solid vinyl polymer were dissolved in 25 g of toluene, and the solution was mixed with 10 g of a carbon black (COLOR BLACK FW1 from Degussa A.G.). Then 2 g of sodium hydroxide were added thereto to neutralize a part of the acidic groups. Further, 300 g of ion-exchange water were added thereto, and the mixture was agitated. The mixture was then emulsified for 30 minutes using an emulsifying machine (NANOMAKER™ from Nanomizer Co.). The thus prepared emulsion was heated at 60° C. under a reduced pressure to remove toluene and a part of water therefrom. In addition, impurities such as residual monomers were removed by ultra filtration. Then the dispersion was heated to 60° C. to perfectly remove water therefrom while substituted with NMP. Thus, a dispersion including a particulate vinyl polymer containing a carbon black therein, i.e., a capsuled carbon black dispersion 1, was prepared. The carbon black capsule in the dispersion 1 had an average particle diameter of 98 nm and a carbon black content of 10%. The weight ratio of the pigment to the water soluble resin is 10/3.

Preparation of Capsuled Carbon Black Dispersion (2)

The procedure for preparation of the capsuled carbon black dispersion (1) was repeated except that the added amount of the vinyl polymer was changed from 3 g to 5 g. Thus, a capsuled carbon black dispersion (2) was prepared.

The weight ratio of the pigment to the water soluble resin is 2/1.

### Example 11

The following components were mixed to prepare a film forming liquid (U).

| | | |
|---|---|---|
| Capsuled carbon black dispersion (1) | 35 | parts |
| Polyimide resin (hard type) | 32.5 | parts |
| | | (solid: 5.8 parts) |
| Polyimide resin (soft type) | 32.5 | parts |
| | | (solid: 5.8 parts) |
| Silicone-based leveling agent | 0.01 | parts |

### Comparative Example 11

The following components were mixed to prepare a film forming liquid (V).

| | | |
|---|---|---|
| Capsuled carbon black dispersion (2) | 35 | parts |
| Polyimide resin (hard type) | 32.5 | parts |
| | | (solid: 5.8 parts) |
| Polyimide resin (soft type) | 32.5 | parts |
| | | (solid: 5.8 parts) |
| Silicone-based leveling agent | 0.01 | parts |

Preparation of Intermediate Transfer Medium

Each of the film forming liquids of Examples 1 to 11 and Comparative Examples 1 to 11 was coated on the inner surface of a cylindrical die having an inside diameter of 300 mm and a length of 500 mm using a dispenser such that the coated liquid has a thickness of 400 μm, wherein the inner surface had been mirror-finished so as to have a surface roughness of 0.2 μm. The cylindrical die was rotated for 15 minutes at a revolution of 1,800 rpm to uniform the coated liquid. Then the cylindrical die was supplied with a hot air of 60° C. for 30 minutes from the outside thereof while rotated at a revolution of 250 rpm, followed by heating at 150° C. for 60 minutes and cooling to room temperature. The crosslinked polyamide acid belt formed on the inner surface of the cylindrical die was peeled therefrom by supplying air between the belt and the die. The belt was set on a metal-cylinder having a surface roughness (Ra) of 1.8 μm. The belt was heated to 360° C. at a heating rate of 3° C./min, and was further heated at 360° C. for 30 minutes while removing water generated due to formation of polyimide ring. Thus, an intermediate transfer medium made of polyimide and having a thickness of 80 μm was prepared.

Methods for Evaluating Film Forming Liquids and Intermediate Transfer Media

1. Preservability of Film Forming Liquid

Each of the film forming liquids of Examples 1 to 11 and Comparative Examples 1 to 11 was contained in a glass bottle and preserved for 4 weeks at 60° C. The preserved film forming liquid was visually observed to determine whether the liquid has precipitation on the bottom of the glass bottle. The preservability was graded into the following three ranks:
A: the liquid has no precipitation
B: the liquid has a small amount of precipitation, which is still acceptable.
C: the liquid has a large amount of precipitation, which is a problem.

In addition, the viscosity of the preserved film forming liquid was measured.

The results are shown in Table 4.

2. Surface Resistivity of Intermediate Transfer Medium and Variation Thereof.

The surface resistivity of each of the intermediate transfer media was measured with an instruments HIGHRESTER IP, MCP-HT260 and HR-100 (probe) (which are manufactured by Mitsubishi Petrochemical Co., Ltd.). The measuring conditions were as follows:

| | |
|---|---|
| Applied voltage: | 100 V |
| Voltage applying time: | 1 minute |
| Environmental conditions: | 25° C. 60% RH |
| Measuring points: | 12 points randomly selected |
| | in the belt extending direction |

Thus, the average surface resistivity and the variation of surface resistivity which is defined as the difference between the maximum and the minimum surface resistivity.

The results are shown in Table 4.

TABLE 4

| | | | | Variation | |
|---|---|---|---|---|---|
| | | Thickness | Surface | of surface | CB/ |
| | Preserv- | of belt | resistivity | resistivity | Resin |
| | ability | (μm) | (log Ω/□) | (log Ω/□) | ratio |
| Ex. 1 | A | 76 | 11.57 | 0.82 | 14:3 |
| Ex. 2 | A | 75 | 11.59 | 0.77 | 10:3 |
| Ex. 3 | A | 76 | 11.42 | 0.56 | 4:1 |
| Ex. 4 | A | 74 | 11.80 | 0.60 | 3:1 |
| Ex. 5 | A | 77 | 11.62 | 0.66 | 14:3 |
| Ex. 6 | A | 76 | 10.71 | 0.42 | 10:3 |
| Ex. 7 | A | 75 | 10.19 | 0.48 | 3:1 |
| Ex. 8 | A | 75 | 10.56 | 0.38 | 10:3 |
| Ex. 9 | A | 76 | 10.74 | 0.40 | 3:1 |
| Ex. 10 | A | 75 | 10.55 | 0.41 | 10:3 |
| Ex. 11 | A | 74 | 12.43 | 0.91 | 10:3 |
| Comp. Ex. 1 | B | 76 | 11.92 | 1.21 | 14:1 |
| Comp. Ex. 2 | B | 75 | 11.42 | 1.50 | 1:1 |
| Comp. Ex. 3 | B | 76 | 11.48 | 1.34 | 10:4 |
| Comp. Ex. 4 | B | 74 | 11.31 | 1.61 | 10:4 |
| Comp. Ex. 5 | B | 77 | 11.10 | 1.25 | 2:1 |
| Comp. Ex. 6 | B | 76 | 10.81 | 2.26 | 14:1 |
| Comp. Ex. 7 | B | 75 | 10.48 | 1.87 | 14:1 |
| Comp. Ex. 8 | B | 75 | 10.09 | 1.81 | 10:4 |
| Comp. Ex. 9 | B | 76 | 10.43 | 1.93 | 2:1 |
| Comp. Ex. 10 | B | 75 | 10.82 | 1.49 | 10:4 |
| Comp. Ex. 11 | B | 74 | 12.43 | 1.65 | 2:1 |

It is clear from Table 4 that the film forming liquids of Examples 1 to 11 have good preservability, and the variation of the surface resistance of the intermediate transfer belts is little (i.e., the variation is not greater than 1.0 (log Ω/□)). In contrast, the preservability of the film forming liquids of Comparative Examples 1 to 11 is inferior to that of the film forming liquids of Examples 1 to 11 although it is still acceptable. However, the variation of the surface resistance of the intermediate transfer belts is relatively large compared to that of intermediate transfer belts of Examples 1 toll (i.e., the variation is greater than 1.0 (log Ω/□)).

### Example 12

Preparation of Pigment Dispersion

The following components were mixed and the mixture was heated to 70° C. using a water bath, to perfectly dissolve the resin dispersant in the solvent.

| | |
|---|---|
| Polyamide acid - polyimide dispersant | 3 parts |
| (acid value of 60 mgKOH/g, weight average | |
| molecular weight of 13,000) | |
| Monoethanol amine | 2 parts |
| N-methyl pyrrolidone | 81 parts |

Then 14 parts by weight of a carbon black (COLOR BLACK S170 from Degussa A.G.) were added to the resin solution, and the mixture was subjected to a pre-mixing treatment for 30 minutes. Then the mixture was subjected to a dispersion treatment, the conditions of which are as follows:

| | |
|---|---|
| Dispersing machine: | SAND GRINDER (from Igarashi |
| | Machine Manufacturing Co., Ltd.) |
| Dispersing medium: | zirconia beads with a |
| | particle diameter of 1 mm |
| Filling factor of dispersing medium: | 50% |
| Dispersion time: | 3 hours |

Further, the dispersion was subjected to a centrifugal treatment for 20 minutes at 12000 rpm, to remove coarse particles.

Preparation of Film Forming Liquid (a)

The following components were mixed to prepare a film forming liquid (a).

| | | |
|---|---|---|
| Pigment dispersion prepared above | 25 | parts |
| N-methyl pyrrolidone | 8 | parts |
| Polyimide resin | 33 | parts |
| (U VARNISH S from Ube Industries, Ltd.) | | (solid: 6 parts) |
| Polyimide resin | 33 | parts |
| (U VARNISH A from Ube Industries, Ltd.) | | (solid: 6 parts) |
| Silicone-based leveling agent | 0.01 | parts |

In this film forming liquid (a), the weight ratio of the pigment (carbon black) to the resin dispersant (polyamide acid-polyimide resin dispersant) is 14/3.

### Example 13

Preparation of Pigment Dispersion

The following components were mixed and the mixture was heated to 70° C. using a water bath, to perfectly dissolve the resin in the solvent.

| | |
|---|---|
| Polyamide acid - polyimide dispersant | 6 parts |
| (acid value of 188 mgKOH/g, weight average | |
| molecular weight of 15000) | |
| Triethanol amine | 4 parts |
| N-methyl pyrrolidone | 70 parts |

Then 20 parts by weight of a carbon black (PRINTEX U from Degussa A.G.) were added to the resin solution, and the mixture was subjected to a pre-mixing treatment for 30 minutes. Then the mixture was subjected to a dispersion treatment, the conditions of which are as follows:

| | |
|---|---|
| Dispersing machine: | PEARL MILL (from Ashizawa |
| | Finetech Co., Ltd.) |
| Dispersing medium: | glass beads with a |
| | particle diameter of 1 mm |
| Filling factor of dispersing medium: | 50% |
| Liquid treating speed: | 100 ml/min |

Further, the dispersion was subjected to a centrifugal treatment for 20 minutes at 12,000 rpm, to remove coarse particles.

Preparation of Film Forming Liquid (b)

The following components were mixed to prepare a film forming liquid (b).

| | | |
|---|---|---|
| Pigment dispersion prepared above | 20 | parts |
| N-methyl pyrrolidone | 6 | parts |
| Polyimide resin | 37 | parts |
| (U VARNISH S from Ube Industries, Ltd.) | | (solid: 6.5 parts) |
| Polyimide resin | 37 | parts |
| (U VARNISH A from Ube Industries, Ltd.) | | (solid: 6.5 parts) |
| Silicone-based leveling agent | 0.01 | parts |

In this film forming liquid (b), the weight ratio of the pigment (carbon black) to the resin dispersant (polyamide acid-polyimide dispersant) is 10/3.

### Example 14

Preparation of Pigment Dispersion

The following components were mixed and the mixture was heated to 70° C. using a water bath, to perfectly dissolve the resin in the solvent.

| | |
|---|---|
| Polyamide acid - polyimide dispersant | 5 parts |
| (acid value of 80 mgKOH/g, weight average | |
| molecular weight of 6,700) | |
| Aminomethyl propanol | 2 parts |
| N-methyl pyrrolidone | 73 parts |

Then 20 parts by weight of a carbon black (COLOR BLACK FW1 from Degussa A.G.) were added to the resin solution, and the mixture was subjected to a pre-mixing treatment for 30 minutes. Then the mixture was subjected to a dispersion treatment, the conditions of which are as follows:

| | |
|---|---|
| Dispersing machine: | PEARL MILL (from Ashizawa |
| | Finetech Co., Ltd.) |
| Dispersing medium: | glass beads with a |
| | particle diameter of 1 mm |
| Filling factor of dispersing medium: | 50% |
| Liquid treating speed: | 100 ml/min |

Further, the dispersion was subjected to a centrifugal treatment for 20 minutes at 12,000 rpm, to remove coarse particles.

Preparation of Film Forming Liquid (c)

The following components were mixed to prepare a film forming liquid (c).

| | | |
|---|---|---|
| Pigment dispersion prepared above | 20 | parts |
| N-methyl pyrrolidone | 6 | parts |
| Polyimide resin | 37 | parts |
| (U VARNISH S from Ube Industries, Ltd.) | | (solid: 6.5 parts) |
| Polyimide resin | 37 | parts |
| (U VARNISH A from Ube Industries, Ltd.) | | (solid: 6.5 parts) |
| Silicone-based leveling agent | 0.01 | parts |

In this film forming liquid (c), the weight ratio of the pigment (carbon black) to the resin dispersant (polyamide acid-polyimide dispersant) is 4/1.

### Example 15

Preparation of Pigment Dispersion

The following components were mixed and the mixture was heated to 70° C. using a water bath, to perfectly dissolve the resin dispersant in the solvent.

| | |
|---|---|
| Polyamide acid - polyimide dispersant | 5 parts |
| (acid value of 188 mgKOH/g, weight average | |
| molecular weight of 15,000) | |
| Monoethanol amine | 3 parts |
| N-methyl pyrrolidone | 77 parts |

Then 15 parts by weight of a carbon black (MOGUL L from Cabot Co.) were added to the resin solution, and the mixture was subjected to a pre-mixing treatment for 30 minutes. Then the mixture was subjected to a dispersion treatment, the conditions of which are as follows:

| | |
|---|---|
| Dispersing machine: | SAND GRINDER (from Igarashi |
| | Machine Manufacturing Co., Ltd.) |
| Dispersing medium: | zirconia beads with a |
| | particle diameter of 1 mm |
| Filling factor of dispersing medium: | 50% |
| Dispersion time: | 3 hours |

Further, the dispersion was subjected to a centrifugal treatment for 20 minutes at 12,000 rpm, to remove coarse particles.

Preparation of Film Forming Liquid (d)

The following components were mixed to prepare a film forming liquid (d).

| | | |
|---|---|---|
| Pigment dispersion prepared above | 25 | parts |
| N-methyl pyrrolidone | 6 | parts |
| Polyimide resin | 35 | parts |
| (U VARNISH S from Ube Industries, Ltd.) | | (solid: 6.3 parts) |
| Polyimide resin | 35 | parts |
| (U VARNISH A from Ube Industries, Ltd.) | | (solid: 6.3 parts) |
| Silicone-based leveling agent | 0.01 | parts |

In this film forming liquid (d), the weight ratio of the pigment (carbon black) to the resin dispersant (polyamide acid-polyimide resin dispersant) is 3/1.

### Example 16

The procedure for preparation of the film forming liquid (a) in Example 12 was repeated except that the carbon black was replaced with PRINTEX V from Degussa A.G. Thus, a film forming liquid (e) was prepared.

In this film forming liquid (e), the weight ratio of the pigment (carbon black) to the resin dispersant (polyamide acid-polyimide resin dispersant) is 14/3.

### Comparative Example 12

The procedure for preparation of the film forming liquid (a) in Example 12 was repeated except that the carbon black was replaced with REGAL 660R from Cabot Co. Thus, a film forming liquid (f) was prepared.

In this film forming liquid (f), the weight ratio of the pigment (carbon black) to the resin dispersant (polyamide acid-polyimide resin dispersant) is 14/3.

### Comparative Example 13

The procedure for preparation of the film forming liquid (a) in Example 12 was repeated except that the added amounts of the polyamide acid-polyimide dispersant, monoethanol amine and N-methylpyrrolidone were changed to 14 parts, 9.3 parts and 62.7 parts. Thus, a film forming liquid (g) was prepared.

In this film forming liquid (g), the weight ratio of the pigment (carbon black) to the resin dispersant (polyamide acid-polyimide resin dispersant) is 1/1.

### Comparative Example 14

The procedure for preparation of the film forming liquid (c) in Example 14 was repeated except that the resin dispersant was changed to a styrene-acrylic acid-butyl acrylate copolymer having a weight average molecular weight of 2,800 and an acid value of 115 mgKOH/g. Thus, a film forming liquid (h) was prepared.

In this film forming liquid (h), the weight ratio of the pigment (carbon black) to the resin dispersant (styrene-acrylic acid-butyl acrylate copolymer) is 10/3.

### Comparative Example 15

The procedure for preparation of the film forming liquid (b) in Example 13 was repeated except that the carbon black was replaced with SPECIAL BLACK 6 from Degussa A.G. Thus, a film forming liquid (i) was prepared.

In this film forming liquid (i), the weight ratio of the pigment (carbon black) to the resin dispersant (polyamide acid-polyimide resin dispersant) is 10/3.

### Comparative Example 16

The procedure for preparation of the film forming liquid (d) in Example 15 was repeated except that the carbon black was replaced with REVEN 140 from Columbian Carbon Co. Thus, a film forming liquid (j) was prepared.

In this film forming liquid (j), the weight ratio of the pigment (carbon black) to the resin dispersant (polyamide acid-polyimide resin dispersant) is 3/1.

### Comparative Example 17

The procedure for preparation of the film forming liquid (a) in Example 12 was repeated except that the carbon black was replaced with #2400 from Mitsubishi Kasei Corp. Thus, a film forming liquid (k) was prepared.

In this film forming liquid (k), the weight ratio of the pigment (carbon black) to the resin dispersant (polyamide acid-polyimide resin dispersant) is 14/3.

### Comparative Example 18

The procedure for preparation of the film forming liquid (a) in Example 12 was repeated except that the added amounts of the resin dispersion, monoethanol amine and N-methyl pyrrolidone were changed to 1 part, 1 part and 84 parts, respectively. Thus, a film forming liquid (1) was prepared.

In this film forming liquid (1), the weight ratio of the pigment (carbon black) to the resin dispersant (polyamide acid-polyimide resin dispersant) is 14/1.

The thus prepared film forming liquids and the intermediate transfer media of Examples 11 to 16 and Comparative Examples 12 to 18 were evaluated by the above-mentioned methods.

The results are shown in Table 5.

TABLE 5

| | | | | Variation of |
|---|---|---|---|---|
| | | Thickness | Surface | surface |
| | | of belt | resistivity | resistivity |
| | Preservability | (μm) | (log Ω/□) | (log Ω/□) |
| Ex. 12 | A | 76 | 11.57 | 0.82 |
| Ex. 13 | A | 75 | 11.59 | 0.77 |
| Ex. 14 | A | 76 | 11.42 | 0.56 |
| Ex. 15 | A | 74 | 11.80 | 0.60 |
| Ex. 16 | A | 77 | 11.62 | 0.66 |
| Comp. Ex. | B | 76 | 11.92 | 1.21 |
| 12 | | | | |
| Comp. Ex. | B | 75 | 11.42 | 1.50 |
| 13 | | | | |
| Comp. Ex. | B | 76 | 11.48 | 1.34 |
| 14 | | | | |
| Comp. Ex. | B | 74 | 11.31 | 1.61 |
| 15 | | | | |
| Comp. Ex. | B | 77 | 11.10 | 1.25 |
| 16 | | | | |
| Comp. Ex. | B | 76 | 10.81 | 2.26 |
| 17 | | | | |
| Comp. Ex. | B | 75 | 10.48 | 1.87 |
| 18 | | | | |

It is clear from Table 5 that the film forming liquids of Examples 12 to 16 have good preservability, and the variation of the surface resistance of the intermediate transfer belts is little (i.e., the variation is not greater than 1.0 (log Ω/□)). In contrast, the preservability of the film forming liquids of Comparative Examples 12 to 18 is inferior to that of the film forming liquids of Examples 12 to 16 although it is still acceptable. However, the variation of the surface resistance of the intermediate transfer belts is relatively large compared to that of intermediate transfer belts of Examples 12 to 16 (i.e., the variation is greater than 1.0 (log Ω/□)).

### Effects of the Present Invention

As can be understood from the above description, the intermediate transfer medium of the present invention has good resistivity uniformity. Therefore, when the intermediate transfer medium is used for image forming apparatus, the image forming apparatus can stably produce images have good image qualities (such as little image density variation) for a long period of time.

In addition, the film forming liquid for use in preparing the intermediate transfer medium of the present invention has good carbon black dispersibility and good preservability. Therefore, the resultant intermediate transfer medium has good resistivity uniformity. The film forming liquid can be used for various molding methods of preparing an intermediate transfer medium.

Further, it is clear than the image forming apparatus using the intermediate transfer medium of the present invention can produce images with good image qualities.

This document claims priority and contains subject matter related to Japanese Patent Applications Nos. 2003-422391, 2003-423870 and 2004-327755, filed on Dec. 19, 2003, Dec. 19, 2003 and Nov. 11, 2004, respectively, incorporated herein by reference.

Having now fully described the invention, it will be apparent to one of ordinary skill in the art that many changes and modifications can be made thereto without departing from the spirit and scope of the invention as set forth therein.

1. An intermediate transfer medium comprising:
a layer comprising:
an acidic carbon black including volatile components of from 3.5 to 8.0% by weight;
at least one of a water soluble resin having a weight average molecular weight of from 3,000 to 30,000, and a resin dispersant having a weight average molecular weight of from 3,000 to 300,000 which is selected from the group consisting of polyamide acids, polyimides, and block copolymers including a unit containing at least one of a polyamide acid and a polyimide; and
a binder resin,
wherein a weight ratio (CB/R) of the carbon black (CB) to the at least one (R) of the water soluble resin and the resin dispersant is from 3/1 to 10/1.

2. The intermediate transfer medium according to claim 1, wherein the layer comprises a water soluble resin having a weight molecular weight of from 5,000 to 15,000.

3. The intermediate transfer medium according to claim 1, wherein the layer comprises a water soluble resin selected from the group consisting of acrylic acid-butyl acrylate-methyl methacrylate copolymers, styrene-maleic acid ester-maleic anhydride copolymers, and polyvinyl pyrrolidone.

4. The intermediate transfer medium according to claim 1, wherein the layer includes a water soluble resin, and wherein the weight ratio (CB/R) of the carbon black (CB) to the water soluble resin (R) is from 10/3 to 10/1.

5. The intermediate transfer medium according to claim 1, wherein the layer comprises a resin dispersant having a weight molecular weight of from 5,000 to 150,000.

6. The intermediate transfer medium according to claim 1, wherein the layer comprises a resin dispersant comprising a repeat unit having a biphenyl skeleton in an amount not less than 40% by mole.

7. The intermediate transfer medium according to claim 1, wherein the outermost layer includes a resin dispersant, and wherein the weight ratio (CB/R) of the carbon black (CB) to the resin dispersant (R) is from 10/3 to 10/1.

8. The intermediate transfer medium according to claim 1, wherein the carbon black comprises volatile components in an amount of from 4.5 to 6.0% by weight.

9. The intermediate transfer medium according to claim 1, wherein the acidic carbon black is a carbon black selected from the group consisting of self-dispersible carbon blacks comprising a resin grafted on a surface thereof and self-dispersible capsuled carbon black in which a carbon black is capsuled with a resin.

10. The intermediate transfer medium according to claim 9, wherein each of the resin and the particulate resin is selected from the group consisting of acrylic acid-butyl acrylate-methyl methacrylate copolymers, styrene-maleic acid ester-maleic anhydride copolymers and polyvinyl pyrrolidone.

11. The intermediate transfer medium according to claim 1, wherein the carbon black has an average primary particle diameter of from 10 nm to 300 nm.

12. The intermediate transfer medium according to claim 1, wherein the binder resin comprises a resin selected from the group consisting of polyimide resins, modified polyimide resins, and polyamideimide resins.

13. The intermediate transfer medium according to claim 1, wherein the layer is an outermost layer, and wherein the layer has a surface resistivity of form 10⁸ to 10¹² Ω/□.

14. The intermediate transfer medium according to claim 1, wherein the intermediate transfer medium consists essentially of the layer.

15. The intermediate transfer medium according to claim 1, wherein the intermediate transfer medium comprises at least two layers, one of which is the layer.

16. The intermediate transfer medium according to claim 1, wherein the intermediate transfer medium is an endless form.

17. A film forming liquid comprising:
a water soluble organic solvent;
an acidic carbon black comprising volatile components of from 3.5 to 8.0% by weight;
at least one of a water soluble resin having a weight average molecular weight of from 3,000 to 30,000, and a resin dispersant having a weight average molecular weight of from 3,000 to 300,000, which is selected from the group consisting of water-soluble resins, polyamide acids, polyimides, and block copolymers including a unit containing at least one of a polyamide acid and a polyimide; and
a binder resin,
wherein a weight ratio (CB/R) of the carbon black (CB) to the at least one (R) of the water soluble resin and the resin dispersant is from 3/1 to 10/1.

18. The film forming liquid according to claim 17, wherein the film forming liquid comprises a water soluble resin having a weight molecular weight of from 5,000 to 15,000.

19. The film forming liquid according to claim 17, wherein the film forming liquid comprises a water soluble resin selected from the group consisting of acrylic acid-butyl acrylate-methyl methacrylate copolymers, styrene-maleic acid ester-maleic anhydride copolymers, and polyvinyl pyrrolidone.

20. The film forming liquid according to claim 17, wherein the film forming liquid comprises a water soluble resin, and wherein the weight ratio (CB/R) of the carbon black (CB) to the water soluble resin (R) is from 10/3 to 10/1.

21. The film forming liquid according to claim 17, wherein the film forming liquid comprises a resin dispersant having a weight molecular weight of from 5,000 to 150,000.

22. The film forming liquid according to claim 17, wherein the film forming liquid comprises a resin dispersant comprising a repeat unit having a biphenyl skeleton in an amount not less than 40% by mole.

23. The film forming liquid according to claim 17, wherein the film forming liquid includes a resin dispersant, and wherein the weight ratio (CB/R) of the carbon black (CB) to the resin dispersant (R) is from 10/3 to 10/1.

24. The film forming liquid according to claim 17, wherein the carbon black comprises volatile components in an amount of from 4.5 to 6.0% by weight.

25. The film forming liquid according to claim 17, wherein the acidic carbon black is a carbon black selected from the group consisting of self-dispersible carbon blacks comprising a resin grafted on a surface thereof and self-dispersible capsuled carbon blacks in which a carbon black is capsuled with a resin.

26. The film forming liquid according to claim 25, wherein each of the resin and the particulate resin is selected from the group consisting of acrylic acid-butyl acrylate-methyl methacrylate copolymers, styrene-maleic acid ester-maleic anhydride copolymers and polyvinyl pyrrolidone.

27. The film forming liquid according to claim 17, wherein the carbon black has an average primary particle diameter of from 10 nm to 300 nm.

28. The film forming liquid according to claim 17, wherein the binder resin is a resin selected from the group consisting of polyimide resins, modified polyimide resins, and polyamideimide resins.

29. An image forming apparatus comprises:
at least one image bearing member;
at least one charger configured to charge the at least one image forming apparatus to form an electrostatic latent image on the image bearing member;
at least one developing device configured to develop the electrostatic latent image to form a toner image;
a transfer device configured to transfer the toner image onto a receiving material via an intermediate transfer medium; and
a fixing device configured to fix the toner image on the receiving material,
wherein the intermediate transfer medium is the intermediate transfer medium according to claim 1.
